(19) United States
(12) Patent Application Publication
(10) Pub. No.: US 2010/0319647 A1
(43) Pub. Date: Dec. 23, 2010

(54) COMBINATION STRUCTURE OF PISTON RING AND CYLINDER LINER FOR INTERNAL COMBUSTION ENGINE

(75) Inventors: Katsuaki Ogawa, Saitama (JP); Tsugane Hirase, Saitama (JP)

Correspondence Address: GREENBLUM & BERNSTEIN, P.L.C., 1950 ROLAND CLARKE PLACE, RESTON, VA, 20191, US

(73) Assignee: NIPPON PISTON RING CO., LTD., Saitama (JP)

(21) Appl. No.: 12/743,825

(22) PCT Filed: Nov. 27, 2008
(86) PCT No.: PCT/JP2008/071556

§ 371 Date: Aug. 16, 2010

(30) Foreign Application Priority Data
Nov. 30, 2007 (JP) 2007-311532

(51) Int. Cl. F02F 1/00

(52) U.S. Cl. 123/193.2

(57) ABSTRACT

An object of the present invention is to provide a cylinder structure reduced in mutual damage caused by a sliding operation of a piston ring and a cylinder liner when the piston ring having a linear expansion property which follows linear expansion of the cylinder liner made of an aluminum alloy is used. In order to achieve the object, a combination structure of the piston ring and the cylinder liner for an internal combustion engine described below is employed. In the cylinder liner for an internal combustion engine, the inner circumferential surface satisfies the conditions, a ten-point height of roughness profile (Rz_{JIS94}) of 0.5 μm to 1.0 μm, a core roughness depth (Rk) of 0.2 μm to 0.4 μm, a reduced peak height (Rpk) of 0.05 μm to 0.1 μm and a reduced valley depths (Rvk) of 0.08 μm to 0.2 μm. In the piston ring, the sliding surface against to an inner circumferential surface in the cylinder liner satisfies the conditions, a ten-point height of roughness profile (Rz_{JIS94}) of not more than 1.6 μm and a reduced peak height (Rpk) of not more than 0.3 μm. The piston ring is used at a contact pressure of 0.03 MPa to 0.2 MPa against to the inner circumferential surface of the cylinder liner.

### TECHNICAL FIELD

The present invention relates to a combination structure of a piston ring and a cylinder liner for an internal combustion engine. The present invention particularly relates to an optimal combination of a cylinder liner that constitutes an inner circumferential surface of a cylinder made of an aluminum alloy that holds a piston and a piston ring provided on a piston which slides along the cylinder liner.

### BACKGROUND ART

In recent years, a body weight of automobiles has been reduced to improve efficiency of fuel consumption. So, it is required to reduce a weight of each component while maintaining or improving its performance, quality, and a price for each component of the automobile. For example, for a cylinder that holds a piston of an internal combustion engine, ferrous materials such as cast iron, steel, and the like have been used in view of a mechanical property and a price required for a cylinder. However, although the cylinder made of such a ferrous material is excellent in mass productivity and a price, the cylinder has a drawback of a heavy weight. Therefore, the ferrous material cannot be a material which can reduce the component weight mentioned above.

In order to reduce the weight of the cylinder, using an aluminum alloy as a raw material of the cylinder has been examined. When the cylinder is manufactured with an aluminum alloy, weight reduction of the cylinder can be achieved more easily than when the cylinder is manufactured with the ferrous material. However, aluminum alloys have a feature that an alloy component is precipitated to be a large granular object and the granular objects are dispersed in the structure. In contrast, as for the ferrous material, granular objects of intermetallic compounds, carbon, and the like may exist in a structure with a certain amount, such granular objects are finer than the granular objects of the alloy component in the structure of the aluminum alloy.

So, in the cylinder manufactured with the ferrous material, the granular objects included in the structure at an inner circumferential surface of the cylinder liner which functions as the sliding surface against to the piston ring may be in the state not to make wear in both the cylinder liner and the piston ring remarkable to be a factor that affects on longer life span and durability of an internal combustion engine. However, in the cylinder manufactured with an aluminum alloy, when the hard granular objects included in the structure protrude at the inner circumferential surface function as the sliding surface of the cylinder liner against to the piston ring, wear and mutual damage in the cylinder liner and the piston ring are made remarkable. So, achieving of longer life and durability as an internal combustion engine is made difficult.

In order to solve such a problem, Patent Document 1 discloses a technology to provide an inexpensive piston ring and piston coating having slight lubricating oil consumption in which a fine-grained hard particles are formed from a molten metal and a proportion of hard particles in a matrix is made high, and the hard particles in the matrix improve the wear resistance and load carrying capacity at the sliding surface. Specifically, hard particles having a plateau-like surface are provided at the inner circumferential surface to be the sliding surface of the cylinder liner against to the piston ring to make the hard particles protrude from the surface of the matrix of an aluminum alloy used for formation in the cylinder liner. In the technology, spray compression is carried out on the molten metal of a hypereutectic aluminum silicon alloy having fine silicon primary crystal and an intermetallic phase formed as hard particles to mold a material. The material is molded by extrusion molding into a shape close to the cylinder liner. Subsequently, the sliding surface is subjected to precision machining and chemical treatment to finish the plateau-like surface on the hard particles protruded from the surface of the aluminum alloy matrix.

On the other hand, the piston ring is provided on the piston for an internal combustion engine held in the cylinder. In the operation of the internal combustion engine, the piston ring is made slide along the cylinder liner that constitutes the inner circumferential surface of the cylinder that is made of an aluminum alloy and holds the piston. Usually, the piston ring is used in the state provided at an outer circumference of a piston head in combination of a compression ring (a first ring and a second ring) and an oil ring as one set. Then, the piston ring is formed with a material in consideration of properties, wear resistance, scuffing resistance and the like in order to be free from reduction in an engine output and/or increasing of lubricating oil consumption caused by the material quality of the piston ring. For example, as for the first ring, a ring made of martensite stainless steel which sliding surface against to the cylinder liner is nitrided, a ring made of SWOSC-V steel which sliding surface against to the cylinder liner is plated with chromium, etc. have been widely used. Moreover, a ring made of high grade cast iron or a ring made of alloy cast iron is used for the second ring. Particularly, a ring made of high grade cast iron which sliding surface against to the cylinder liner is plated with chromium is widely used. Further, as for the oil ring, a product referred to as a two-piece type or three-piece type is used.

However, when a conventional piston ring is used in combination with a cylinder made of an aluminum alloy, tendency that an amount of blow-by gas generation is increased. The reason why the blow-by gas generates is that a coefficient of linear expansion of the cylinder and the cylinder liner both made of an aluminum alloy is larger than that of the cylinder and the cylinder liner both made of a ferrous material. In other words, the first ring having a smaller coefficient of linear expansion never fully follow the shape of a cylinder made of an aluminum alloy expanded and results a broader closed gap. Then the first ring is made to fail gas sealing of a combustion chamber in the cylinder to cause blow-by of a combustion gas. As a result, response ability of the engine is reduced and the engine power is made lower.

Then, Patent Document 2 discloses a piston ring that follows linear expansion of a cylinder made of an aluminum alloy as a piston ring used for a cylinder made of an aluminum alloy. Technology disclosed in Patent Document 2 has solved the above-mentioned problem by using austenite stainless steel having a coefficient of thermal expansion of not less than 15×10⁻⁶/° C. for the piston ring that slides along the cylinder made of an aluminum alloy. Particularly, it is made preferable that the piston ring is made of austenite stainless steel containing Ni of not less than 3.5 weight % and not more than 17 weight % and Cr of not less than 15 weight % and not more than 20 weight %. Also, the piston ring disclosed in Patent Document 2 is preferred to be provided with nitride layer formed by an interstitial element type nitriding treatment, or treated with chromium plating, composite chromium plating, composite plating, thermal spraying, physical vapor deposition (PVD), and chemical vapor deposition (CVD).

### [Patent Document 1]

### Japanese Patent Laid-Open No. 9-19757

### [Patent Document 2]

### Japanese Patent Laid-Open No. 2000-145963

### DISCLOSURE OF THE INVENTION

### Problems to be Solved by the Invention

However, object of the technology disclosed in Patent Document 1 is to utilize an inexpensive piston ring and coating on the piston. The matter recognized in the description is that the sliding surface of the cylinder liner is carried out precision machining followed by chemical treatment of chemical polishing using an alkaline solution to finish surface of the hard particles which exist on the surface of the cylinder liner and protruded from the surface of the aluminum alloy matrix to be plateau-like shape Although the technology is mentioned to be applicable for all the piston rings, but include the following problems.

Chemical treatment disclosed in Patent Document 1 is difficult in process control, and it makes hard to obtain cylinder liner surface having an even surface state stably. The aluminum alloy constituting the cylinder liner includes different components, granular silicon primary crystal, inter-metallic compounds such as Al₂O₃, Mg₂Si and the like and these components respectively have a different dissolution rate to an alkaline solution used for chemical polishing. So, irregular protrusions and depressions protruded from an aluminum matrix are inevitably formed on the cylinder liner surface. As a result, touching of the sliding surface of the piston ring onto the cylinder liner surface is not stable, and a quality of an engine to be manufactured may be fluctuated.

As it can be recognized from the above description, even when the cylinder (cylinder liner) disclosed in Patent Document 1 and the piston ring disclosed in Patent Document 2 that can follow linear expansion of the cylinder made of the aluminum alloy is used in combination, it may not satisfy a requirement of persons skilled in the art. Moreover, in the invention disclosed in Patent Document 2, it may be difficult to assure sufficient durability performance in a combination structure in which the cylinder liner made of an aluminum alloy is provided at an inner circumferential surface of the cylinder to hold the piston and the piston ring provided on the piston which slides along the cylinder liner according to a surface roughness and/or a composition of the cylinder made of an aluminum alloy.

So, an object of the present invention is to provide a combination structure of a piston ring and a cylinder liner for an internal combustion engine in which the piston ring having a linear expansion close to linear expansion of the cylinder liner when a cylinder is manufactured with an aluminum alloy to reduce mutual damage in the piston ring and the cylinder liner caused in a sliding operation, such as wear, damage by friction, etc.

### Means for Solving the Problems

Then, the present inventors have employed a combination structure of a piston ring and a cylinder liner for an internal combustion engine shown below to solve the above-mentioned problems.

A combination structure of a piston ring and a cylinder liner for internal combustion engine according to the present invention is a combination structure of a piston ring and a cylinder liner for an internal combustion engine in which the piston ring provided on a piston of the internal combustion engine is arranged to slide along the cylinder liner while keeping a predetermined contact pressure against to the cylinder liner which constitutes an inner circumferential surface of the cylinder that is made of an aluminum alloy and holds the piston. The inner circumferential surface of the cylinder liner comprises surface roughness properties 1 of the conditions (1) to (4) shown below. The sliding surface of the piston ring along the inner circumferential surface of the cylinder liner comprises surface roughness properties 2 of the conditions (a) and (b) shown below. The piston ring provided on the piston is used at a contact pressure of 0.03 MPa to 0.2 MPa against to the inner circumferential surface of the cylinder liner.

### [Surface Roughness Properties 1]

(1) A ten-point height of roughness profile (Rz_{JIS94}) provided in JIS B 0601 (1994) is 0.5 μm to 1.0 μm.
(2) A core roughness depth (Rk) provided in DIN 4776 is 0.2 μm to 0.4 μm.
(3) A reduced peak height (Rpk) provided in DIN 4776 is 0.05 μm to 0.1 μm.
(4) A reduced valley depths (Rvk) provided in DIN 4776 is 0.08 μm to 0.2 μm.

### [Surface Roughness Properties 2]

(a) A ten-point height of roughness profile (Rz_{JIS94}) provided in JIS B 0601 (1994) is not more than 1.6 μm.
(b) A reduced peak height (Rpk) provided in DIN 4776 is not more than 0.3 μm.

In the combination structure of the piston ring and the cylinder liner for the internal combustion engine according to the present invention, it is preferable that the cylinder liner is made of the alloy comprising the alloy composition for a cylinder liner 1 shown below.

### [Alloy Composition for a Cylinder Liner 1]

Silicon: 20.0 mass % to 28.0 mass %
Magnesium: 0.4 mass % to 2.0 mass %
Copper: 2.0 mass % to 4.5 mass %
Iron: not more than 0.60 mass %
Nickel: not more than 0.01 mass %
Balance: aluminum and inevitable impurities

In the combination structure of the piston ring and the cylinder liner for the internal combustion engine according to the present invention, it is also preferable that the cylinder liner is made of the alloy comprising the alloy composition for a cylinder liner 2 shown below.

### [Alloy Composition for a Cylinder Liner 2]

Silicon: 20.0 mass % to 28.0 mass %
Magnesium: 0.8 mass % to 2.0 mass %
Copper: 3.0 mass % to 4.5 mass %
Iron: 1.0 mass % to 1.4 mass %
Nickel: 1.0 mass % to 5.0 mass %
Balance: aluminum and inevitable impurities

Next, in the combination structure of the piston ring and the cylinder liner for the internal combustion engine according to the present invention, it is preferable that the piston ring is made of the austenite stainless steel having an alloy composition for a piston ring shown below.

### [Alloy Composition for a Piston Ring]

Nickel: 3.5 mass % to 15.0 mass %
Chromium: 13.0 mass % to 20.0 mass %
Carbon: not more than 0.15 mass %
Silicon: not more than 1.0 mass %
Manganese: not more than 7.5 mass %
Phosphorus: not more than 0.06 mass %
Sulfur: not more than 0.03 mass %
Balance: iron and inevitable impurities

Moreover, in the combination structure of the piston ring and the cylinder liner for the internal combustion engine according to the present invention, it is preferable that the alloy composition for a piston ring further comprises molybdenum of 1 mass % to 4 mass %.

Further, in the combination structure of the piston ring and the cylinder liner for the internal combustion engine according to the present invention, it is preferable that the sliding surface of the piston ring against to the inner circumferential surface in the cylinder liner comprises a nitride layer having a thickness of 30 μm to 150 μm on the surface, and a Vickers hardness UM at the sliding surface is 900 HV0.1 to 1200 HV0.1.

Moreover, in the combination structure of the piston ring and the cylinder liner for the internal combustion engine according to the present invention, it is preferable that the sliding surface of the piston ring against to the inner circumferential surface in the cylinder liner comprises a diamond-like carbon layer on the sliding surface of the piston ring.

Further, in the combination structure of the piston ring and the cylinder liner for the internal combustion engine according to the present invention, it is preferable that both an upper surface of the piston ring and a bottom surface of the piston ring to be settled in a piston ring groove of the piston ring comprise a resin coat layer formed by using either of a heat resistant resin or a filler-containing heat resistant resin which a heat resistant resin contains an inorganic filler.

Then, it is preferable that the heat resistant resin is either of a polybenzimidazole resin or a polyamide-imide resin each having a heat resisting temperature of not less than 150° C.

Further, in the combination structure of the piston ring and the cylinder liner for the internal combustion engine according to the present invention, it is preferable that upper surface of the piston ring and bottom surface of the piston ring comprise a roughened surface prepared by chemical treatment, and the resin coat layer is provided on the roughened surface.

An internal combustion engine of high quality can be provided by using the combination structure of the piston ring and the cylinder liner for an internal combustion engine mentioned above.

### ADVANTAGE OF THE INVENTION

The combination structure of the piston ring and the cylinder liner for an internal combustion engine according to the present invention minimizes wear in both the cylinder liner and the sliding surface of the piston ring, and effectively reduces damage by friction caused in a sliding operation by setting the surface roughness properties in the cylinder liner that constitutes the inner circumferential surface of the cylinder made of an aluminum alloy and the surface roughness of the sliding surface of the piston ring against to the inner circumferential surface of the cylinder liner within a certain range. As a result, life span of the internal combustion engine can be increased, and durability can be improved significantly.

### BEST MODE FOR CARRYING OUT THE INVENTION

Hereinafter, embodiment of a combination structure of a piston ring and a cylinder liner for an internal combustion engine according to the present invention will be explained. In the following explanation, to make it free from confusion on the cylinder liner or the piston ring, the description will be made item by item as much as possible.

In the combination structure of the piston ring and the cylinder liner for an internal combustion engine according to the present invention, the piston ring provided on the piston is used at a predetermined contact pressure against to the inner circumferential surface of the cylinder liner that is made of an aluminum alloy and holds the piston and slides along the cylinder.

Embodiment in the cylinder liner used in the present invention: In the cylinder used for the combination structure of the piston ring and the cylinder liner for the internal combustion engine according to the present invention, the inner circumferential surface of the cylinder liner arranged in the cylinder satisfies the surface roughness properties 1 of conditions (1) to (4) shown below.

Condition (1) in the surface roughness properties 1 is “a ten-point height of roughness profile (Rz_{JIS94}) provided in JIS B 0601 (1994) is 0.5 μm to 1.0 μm”. The ten-point height of roughness profile (Rz_{JIS94}) of less than 0.5 μm may make scuffing resistance poor to reduce stability in performance of an internal combustion engine. In contrast, the ten-point height of roughness profile (Rz_{JIS94}) of exceeding 1.0 μm is too large as the surface roughness and it may result a drastically higher possibility in giving damage by friction on the sliding surface of the piston ring that slides along the surface of the cylinder liner.

Condition (2) in the surface roughness properties 1 is “a core roughness depth (Rk) provided in DIN 4776 is 0.2 μm to 0.4 μm”. The core roughness depth (Rk) of less than 0.2 μm may worsen a sliding property between the inner circumferential surface of the cylinder liner and the sliding surface of the piston ring even if sliding resistance is low. In contrast, the core roughness depth (Rk) of exceeding 0.4 μm may make the sliding resistance excessively large to result poor efficiency of fuel consumption as an internal combustion engine, so it is not preferable.

Condition (3) in the surface roughness properties 1 is “a reduced peak height (Rpk) provided in DIN 4776 is 0.05 μm to 0.1 μm”. In this range, damage by friction at the inner circumferential surface of the cylinder liner and the sliding surface of the piston ring can be reduced, the sliding operation can be stabilized, and excellent scuffing resistance can be achieved. The reduced peak height (Rpk) of less than 0.05 μm makes initial conformity poor so it is not preferable. It is because that at the starting time of the internal combustion engine, it is difficult to quickly establish a state in which the inner circumferential surface of the cylinder liner is made proper to projections and depressions on the sliding surface of the piston ring to allow fluid lubrication between the inner circumferential surface of the cylinder liner and the sliding surface of the piston ring. In contrast, the reduced peak height (Rpk) of exceeding 0.1 μm makes initial conformity also poor because of higher roughness. Also, damage on the sliding surface of the piston ring that slide along to the projections and depressions of the inner circumferential surface of the cylinder liner caused by friction may be drastically increased.

Condition (4) in the surface roughness properties 1 is “reduced valley depths (Rvk) provided in DIN 4776 is 0.08 μm to 0.2 μm”. The reduced valley depths (Rvk) of less than 0.08 μm makes it hard to keep an adequate amount of oil among the projections and depressions between the inner circumferential surface of the cylinder liner and the sliding surface of the piston ring. Therefore, it is difficult to establish the state to allow fluid lubrication for stabilizing the sliding operation, and scuffing resistance is made poor. In contrast, the reduced valley depths (Rvk) of exceeding 0.2 μm results an osmosis flow amount of oil among the projections and depressions between the inner circumferential surface of the cylinder liner and the sliding surface of the piston ring increases, and therefore a sufficient fluid lubrication state can be formed. However, an amount of engine oil consumption is increased, so it is not preferable.

A method for manufacturing the cylinder liner provided in the inner circumferential surface of the cylinder mentioned above is particularly not limited. For example, the cylinder liner is manufactured as follows. A powder material to constitute an aluminum alloy composition is prepared, mixed and melt. The molten material is sprayed by a spray-forming method, followed by compressing, drawing processing and after plastic processing with hammering and the like and the shape is made to be a cylindrical cylinder liner. The product is inserted into a cylinder block by an aluminum die casting. Then, the inner circumferential surface of the cylinder liner is subjected to physical polishing using a hone, buff or the like to make the surface of the inner circumferential surface of the cylinder liner comprise the above-mentioned surface roughness properties. It will be clearly stated that the above-mentioned surface roughness properties of the inner circumferential surface of the cylinder liner can be adjusted by physical polishing using a hone, buff and the like in the present invention. In contrast, such surface roughness properties cannot be achieved by a chemical process disclosed in Patent Document 1 mentioned above.

Then, the aluminum alloy for forming the cylinder liner is preferable to use either of the following two kinds of casting aluminum alloys. The alloy for the cylinder liner mentioned here comprises a composition including silicon, magnesium, copper, iron, nickel, and a balance of aluminum and inevitable impurities, i.e. the alloy composition for the cylinder liner contains hard grains that demonstrate solid lubrication performance in an aluminum matrix. Next, the alloy composition for a cylinder liner 1 and the alloy composition for a cylinder liner 2 will be described one by one.

First, the alloy composition for a cylinder liner 1 will be described. Silicon contained in the alloy composition for a cylinder liner 1 is a component for control of a coefficient of linear expansion of the aluminum alloy, and content is preferable to be in the range of 20.0 mass % to 28.0 mass %. A phase of the silicon contained in the range is a hypereutectic region in the aluminum-silicon alloy phase diagram. So, in a solidification process from a molten metal, primary crystal grains of silicon (pro-eutectic silicon) which performs solid lubricating feature can be crystallized easily. So, it is clear that the silicon content less than 20.0 mass % makes it difficult to crystallize primary crystal grains of pro-eutectic silicon which performs solid lubricating feature. In addition, it is made impossible to form Mg₂Si that is an intermetallic compound made of magnesium and silicon and performs solid lubricating feature, which will be described in detail later. So, silicon of less than 20.0 mass % is not preferable. In contrast, silicon content exceeding 28.0 mass % makes pro-eutectic silicon included in the aluminum matrix after solidification large. Same time, an excessive dispersion density in the base material may make hardness of base material too big to result poor workability in shaping such as cutting and polishing. So, silicon content exceeding 28.0 mass % is not preferable. Further, the silicon content in the range of 23.0 mass % to 28.0 mass % is more preferable.

Magnesium content in the alloy composition for a cylinder liner 1 is preferable to be in the range of 0.4 mass % to 2.0 mass %. Magnesium forms an intermetallic compound with each component of aluminum, copper, and silicon used here and performs solid lubricating feature. However, the content of magnesium of less than 0.4 mass % makes formation of the intermetallic compound hard and increase sliding resistance and a coefficient of friction thereof between the inner circumferential surface of the cylinder liner and the sliding surface of the piston ring. So, magnesium of less than 0.4 mass % is not preferable. In contrast, the content of magnesium exceeding 2.0 mass % makes an amount of the intermetallic compound attributed to magnesium excessive to result a brittle cylinder liner with poor toughness, poor vibration resistance and poor fatigue strength. So, magnesium exceeding 2.0 mass % is not preferable. Further, the magnesium content in the range of 0.8 mass % to 2.0 mass % is more preferable.

Copper content in the alloy composition for a cylinder liner 1 is preferable to be in the range of 2.0 mass % to 4.5 mass %. Copper is widely used as an alloy component to perform the solid lubricating feature to a material for bearing steel, etc. that requires lubricity. Here, copper as an alloy component is used to form Al₂Cu that is an intermetallic compound which performs the solid lubricating feature between copper and aluminum, and a part of the copper component form a solid solution with the aluminum matrix and then both excellent solid lubricating feature and improved fatigue strength are achieved. Here, the copper content less than 2.0 mass % makes the amount of solid-solution of copper in the aluminum matrix decrease to hardly improve toughness as an aluminum alloy and the fatigue strength. In contrast, the copper content exceeding 4.5 mass % provides excess generation of Al₂Cu which is the intermetallic compound that does not form a solid solution with the aluminum matrix to reduce both fatigue strength and toughness of an aluminum alloy. Further, the copper content in the range of 3.0 mass % to 4.5 mass % is more preferable.

Iron content in the alloy composition for a cylinder liner 1 is preferable to be in the range of not more than 0.60 mass %. Iron as an alloy component is added to prevent “shrinkage cracking” which occurs in a production process when molten aluminum alloy to be casted is solidified. So, excess amount of iron is not necessary as an alloy component. In contrast, the iron content exceeding 0.60 mass % may provide excess intermetallic compound in the solidification process such as FeAl₃, α(AlFeSi), β(AlFeSi) and the like having a unique array which is unnecessary in the present invention and cannot be easily dispersion dissolved. Moreover, intermetallic compound is easily segregated on the surface of the cylinder liner and it makes appearance and toughness poor. Further, the iron content is preferable not more than 0.25 mass %. Here, a lower limit of the iron content is not described. However, to prevent “shrinkage cracking”, the iron content is preferable to be 0.001 mass % or more.

Nickel content in the alloy composition for a cylinder liner 1 is preferable to be in the range of not more than 0.01 mass %. Nickel as an alloy component is added to prevent “shrinkage cracking” which occurs in a production process when molten aluminum alloy to be casted is solidified and to improve thermal resistance of the aluminum alloy after solidification, and to make the plastic processing easy. So, excess amount of nickel is not necessary as an alloy component. In contrast, the nickel content exceeding 0.01 mass % may provide excess intermetallic compound such as NiAl₃, which is unnecessary in the present invention in the solidification process to make the toughness of an aluminum alloy poor. Here, a lower limit of the nickel content is not described. However, to prevent “shrinkage cracking”, the nickel content is preferable to be 0.001 mass % or more.

Then, in the alloy composition for a cylinder liner 1, the balance is aluminum and inevitable impurities. The inevitable impurities include manganese and zinc. It is a well-known that silicon and iron are included as inevitable impurities in aluminum. However, the contents level of silicon and iron in the above-mentioned alloy composition for a cylinder liner 1 are not the amount of inevitable impurities, i.e. the contents of silicon and iron should be designated and adjusted as an alloy component to be added.

Next, the alloy composition for a cylinder liner 2 will be described. Here, silicon content in the alloy composition for a cylinder liner 2 is preferable to be in the range of 20.0 mass % to 28.0 mass %. So, the silicon content is the same as in the above-mentioned alloy composition for a cylinder liner 1, and the reason to be the range is also the same. So, in order to avoid duplicated description, description on the silicon content in the alloy composition for a cylinder liner 2 will be omitted here.

Magnesium content in the alloy composition for a cylinder liner 2 is preferable to be in the range of 0.8 mass % to 2.0 mass %. So, the content of magnesium is the same as in the above-mentioned alloy composition for a cylinder liner 1, and the reason to be the range is also the same. So, in order to avoid duplicated description, description on the magnesium content in the alloy composition for a cylinder liner 2 will be omitted here.

Copper content in the alloy composition for a cylinder liner 2 is preferable to be in the range of 3.0 mass % to 4.5 mass %. So, the content of copper is the same as in the above-mentioned alloy composition for a cylinder liner 1, and the reason to be the range is also the same. So, in order to avoid duplicated description, description on the copper content in the alloy composition for a cylinder liner 2 will be omitted here.

Iron content in the alloy composition for a cylinder liner 2 is preferable to be in the range of 1.0 mass % to 1.4 mass %. Iron as an alloy component is added to prevent “shrinkage cracking” which occurs in a production process when molten aluminum alloy to be cast is solidified, and to prevent seizure of an aluminum alloy material onto a surface of a metal mold when the molten aluminum alloy material is sprayed into the metal mold by the spray-forming method. So, the iron content less than 1.0 mass % hardly prevents both “shrinkage cracking” mentioned above and seizure onto the metal mold surface. In contrast, the iron content exceeding 1.4 mass % provides an intermetallic compound such as FeAl₃, α(AlFeSi), β(AlFeSi) and the like in the solidification process which is unnecessary in the present invention and cannot be easily dispersion dissolved and makes mechanical strength such as toughness required for an aluminum alloy for the cylinder liner poor.

Nickel content in the alloy composition for a cylinder liner 2 is preferable to be in the range of 1.0 mass % to 5.0 mass %. Nickel as the alloy component demonstrates the same effect as in the case of the aluminum alloy in the alloy composition for a cylinder liner 1. The nickel content less than 1.0 mass % hardly prevents “shrinkage cracking” and heat resistance properties as an aluminum alloy cannot be improved. In contrast, the nickel content exceeding 5.0 mass % provides an intermetallic compound such as NiAl₃ in solidification process which is unnecessary in the present invention and it makes toughness of an aluminum alloy poor and reduce shock resistance properties remarkably.

Then, also in the alloy composition 2 for the cylinder liner, the balance is aluminum and inevitable impurities. The inevitable impurities include the same components as those in the alloy composition for a cylinder liner 1. However, the contents level of silicon and iron in the above-mentioned alloy composition for a cylinder liner 2 are not the amount of inevitable impurities, i.e. the contents of silicon and iron should be designated and adjusted as an alloy component to be added.

Embodiment of the piston ring used in the present invention: The piston ring used in the present invention satisfies the surface roughness properties 2 of the conditions (a) and (b) shown below on the sliding surface of the piston ring against to the inner circumferential surface of the cylinder liner.

Condition (a) in the surface roughness properties 2 is “the ten-point height of roughness profile (Rz_{JIS94}) provided in JIS B 0601 (1994) is not more than 1.6 μm”. The ten-point height of roughness profile (Rz_{JIS94}) exceeding 1.6 μm is too large as the surface roughness, because a sliding property against to the cylinder liner having the surface roughness properties 1 mentioned above is not stabilized, and stabile performance in the internal combustion engine cannot be achieved. Moreover, damage on the cylinder liner surface that slide along the sliding surface of the piston ring caused by friction may become drastically big. Here, a lower limit of the ten-point height of roughness profile (Rz_{JIS94}) of the sliding surface against to the inner circumferential surface of the cylinder liner of the piston ring is not limited in particular. However, in consideration of adjusting an oil amount penetrate into the projections and depressions between the inner circumferential surface of the cylinder liner and the sliding surface of the piston ring mentioned above, and forming a suitable fluid lubrication state, the ten-point height of roughness profile (Rz_{JIS94}) of the sliding surface of the piston ring is preferable to be not less than 0.1 μm.

Condition (b) in the surface roughness properties 2 is “the reduced peak height (Rpk) provided in DIN 4776 is not more than 0.3 μm”. Based on a premise that the inner circumferential surface of the cylinder liner mentioned above has the above-mentioned surface roughness properties 1, the reduced peak height (Rpk) of not more than 0.3 μm makes damage on the sliding surface of the piston ring and the inner circumferential surface of the cylinder liner by friction reduce very effectively, the sliding operation stabilized and scuffing resistance excellent. The reduced peak height (Rpk) of exceeding 0.3 μm makes the initial running-in property poor because of higher roughness. Also, damage on the projections and depressions of the inner circumferential surface of the cylinder liner that slide along the sliding surface of the piston ring by friction may become higher. Here, a lower limit of the reduced peak height (Rpk) in the surface roughness properties 2 is not specified. However, the reduced peak height (Rpk) is not less than 0.01 μm is preferable to quickly establish a state in which the inner circumferential surface of the cylinder liner is made proper to projections and depressions on the sliding surface of the piston ring to allow fluid lubrication between the inner circumferential surface of the cylinder liner and the sliding surface of the piston ring at the starting time of the internal combustion engine.

Next, in the combination structure of the piston ring and the cylinder liner for the internal combustion engine according to the present invention, austenite stainless steel having an alloy composition for a piston ring described shown below is preferably used for the piston ring.

The alloy composition for a piston ring used in the present invention includes nickel, chromium, carbon, silicon, manganese, phosphorus, sulfur, and the balance of iron and inevitable impurities, and is classified into austenite stainless steel. In other words, in the alloy composition for a piston ring, the nickel content is 3.5 mass % to 15.0 mass %, the chromium content is 13.0 mass % to 20.0 mass %, the carbon content is not more than 0.15 mass %, the silicon content is not more than 1.0 mass %, the manganese content is not more than 7.5 mass %, the phosphorus content is not more than 0.06 mass %, the sulfur content is not more than 0.03 mass %, and the balance is iron and inevitable impurities. With this composition, even when the mixing ratio of the nickel content and the chromium content is varied within the above-mentioned ranges, a stabile high coefficient of linear expansion can be obtained, and the coefficient of linear expansion can be made close to a coefficient of linear expansion of the above-mentioned aluminum alloy for the cylinder liner.

Here, description will be given of nickel that is a basic component of the alloy composition for a piston ring. Nickel content as the alloy composition for a piston ring is preferable to be 3.5 mass % to 15.0 mass %. Nickel content less than 3.5 mass % makes coefficient of linear expansion of austenite stainless steel unstable. In addition, austenite stainless steel has a drawback that the nickel component tends to block penetration of nitrogen atoms to obstruct nitriding in nitriding treatment for forming the nitride layer on the surface of austenite stainless steel. So, the nickel content exceeding 15 mass % makes it difficult to form the nitride layer on the surface of austenite stainless steel, and it takes a long time to form the nitride layer and increase a manufacturing cost remarkably.

Chromium content as the alloy composition for a piston ring is preferable to be 13.0 mass % to 20.0 mass %. The chromium content less than 13.0 mass % makes forming of a fine and firm passivation film of chromium insufficient and results poor corrosion resistance, so it is not preferable. In addition, it makes hard to form a nitride layer having a high level hardness in the nitriding treatment and result poor wear resistance. Further, improvement of heat resistance by solid solution formation of chromium is made hard, so it is not preferable. Moreover, when the nitride layer is formed on the surface of austenite stainless steel, sufficient chromium nitride having a high level hardness is hardly formed, and a nitride layer having a high level hardness is not obtained. In contrast, the chromium content exceeding 20.0 mass % may increase steel material costs. Additionally, when the nitride layer which will be described later is formed on the surface of austenite stainless steel, there is a drawback that the chromium component blocks penetration of nitrogen elements into austenite stainless steel and obstructs nitriding treatment, as well as the nickel component.

Carbon content as the alloy composition for a piston ring is preferable to be not more than 0.15 mass %. In a structure of austenite stainless steel for forming the piston ring, carbon forms carbides and demonstrates solid lubrication performance. However, the carbon content exceeding 0.15 mass % makes an amount of hard carbides existing at a grain boundary increase. Therefore, corrosion resistance is made poor, so it is not preferable.

Silicon content as the alloy composition for a piston ring is preferable to be not more than 1.0 mass %. Silicon performs as an austenite formation element to some extent, and functions as a component that improves wear resistance performance. However, silicon content exceeding 1.0 mass % tends to make heat resistance of austenite stainless steel for forming the piston ring poor, so it is not preferable.

Manganese content as the alloy composition for a piston ring is preferable to be not more than 7.5 mass %. Manganese as a component of austenite stainless steel for forming the piston ring performs as an austenite formation element. However, when the content of manganese is made to exceed 7.5 mass %, austenite formation ability of manganese is saturated, and is no longer improved. In addition, excess amount of manganese tends to segregate at the grain boundary of austenite stainless steel and mechanical strength is made poor, so it is not preferable.

Moreover, phosphorus content is preferable to be not more than 0.06 mass %. Also, sulfur content is preferable to be not more than 0.03 mass %. When phosphorus and sulfur as the alloy composition for a piston ring are uniformly dispersed in a crystal of austenite stainless steel as a fine phosphorus compound and/or sulfide, phosphorus and sulfur provide larger mechanical strength by a particle dispersion effect, and provide as a component that improves wear resistance. However, when phosphorus content as an alloy component exceeds 0.06 mass %, content of sulfur exceeding 0.03 mass % tends to segregate both phosphorus compounds and sulfide at the grain boundary, and it makes the quality of the material brittle. Moreover, phosphorus compounds and sulfides in the crystal of austenite stainless steel may tend to be big to be a site where a stress is concentrated when deformation stress is applied. That is, it makes generation of micro cracks by vibration easy and makes durability performance poor, so it is not preferable.

Next, in the combination structure of the piston ring and the cylinder liner for the internal combustion engine according to the present invention, it is preferable that, the piston ring further includes molybdenum of 1 mass % to 4 mass % in the alloy composition for a piston ring. Molybdenum provides increased mechanical strength and toughness in an alloy for the piston ring, and also heat resistance that prevent softening of the material even at a high temperature operation. Moreover, improved corrosion resistance and sulfuric acid resistance is provided by containing molybdenum of not less than 1 mass %. The molybdenum content of less than 1 mass % hardly provide sufficient heat resistance and increased mechanical strength. In contrast, the molybdenum content exceeding 4 mass % may provide no change in performance. Therefore, it is just a waste of resources and not preferable.

Further, in the combination structure of the piston ring and the cylinder liner for the internal combustion engine according to the present invention, it is preferable that, the sliding surface of the piston ring against to the inner circumferential surface in the cylinder liner comprises a nitride layer having a thickness of 30 μm to 150 μm on the surface, and a Vickers hardness (HV) at the sliding surface is 900 HV0.1 to 1200 HV0.1. The nitride layer thickness is a thickness in which a hardness of not less than 700 HV0.1 is obtained by measuring hardness distribution in a cross section of the nitride layer by a micro-Vickers hardness tester.

Here, a nitride layer thickness provided on the sliding surface of the piston ring will be described. The nitride layer thickness is preferable to be in the range of 30 μm to 150 μm. The nitride layer thickness less than 30 μm is insufficient for practical use in consideration of a nitride layer thickness worn out under normal operations of the internal combustion engine. In contrast, as is apparent in a relationship between the nitride layer thickness formed on three kinds of stainless steel and the Vickers hardness of the nitride layer shown in FIG. 1, the nitride layer thickness exceeding 150 μm may cause breakage easily, so it is not preferable. Moreover, in the view for reduction of a manufacturing cost and prevention of a waste of resources are considered, the nitride layer thickness is more preferable to be in the range of 30 μm to 90 μm, as recognized in FIG. 1.

Moreover, the piston ring is preferable to be made of austenite stainless steel in which chromium as the alloy element is made bond with nitrogen atoms penetrated in a nitriding treatment and form chromium nitride having a high level hardness to further improve the hardness of the nitride layer to be the Vickers hardness (HV) of 900 HV0.1 to 1200 HV0.1. When the Vickers hardness (HV) is less than 900 HV0.1, driving of the internal combustion engine may provides remarkable abrasive wear caused by friction on the sliding surface of the piston ring and the inner circumferential surface of the cylinder liner. So, it is difficult to make life span as the internal combustion engine longer. In contrast, the Vickers hardness (HV) exceeding 1200 HV0.1 provides excessively hard surface on the sliding surface of the piston ring and it may be brittle and fragile to damage an aluminum bore aggressively, so it is not preferable. So, the piston ring made of austenite stainless steel comprising the nitride layer having the thickness and hardness of the above-mentioned ranges improves the wear resistance and scuffing resistance of the sliding surface of the piston ring drastically when used in combination with the above-mentioned cylinder liner. Further, the hardness of the nitride layer within 950 HV0.1 to 1100 HV0.1 is more preferable.

Nitride layer mentioned here is formed by interstitial nitriding treatment in which nitrogen atoms penetrate from the surface of the piston ring made of austenite stainless steel. In order to perform such nitriding treatment, any types of nitriding treatment such as gas nitriding, ion nitriding, salt bath nitriding, sulphonitriding, etc can be applicable. By performing the nitriding treatment, longer life span required for the internal combustion engine can be achieved even when the piston ring made of austenite stainless steel which has been said not suitable for the piston ring because of excess abrasive wear is used in combination with the cylinder liner made of the aluminum alloy. Nitriding treatment at this time may be performed on the entire surface of the piston ring surface or just the sliding surface of the piston ring that slide along the cylinder liner. Further, the surface of the nitride layer described above is also preferable to be performed surface treatment on it, using a method such as chromium plating, composite chromium plating, composite plating, thermal spraying, physical vapor deposition (PVD), and chemical vapor deposition (CVD).

Moreover, in the combination structure of the piston ring and the cylinder liner for the internal combustion engine according to the present invention, it is also preferable that the sliding surface of the piston ring against to the inner circumferential surface of the cylinder liner comprises a diamond-like carbon layer (hereinafter, referred to as a “DLC layer”.) on the sliding surface of the piston ring. The DLC layer may be provided in the outermost layer of the sliding surface of the piston ring provided with the nitride layer mentioned above, or may be formed directly on the sliding surface without the nitride layer. The DLC layer is a popular low friction material having a coefficient of friction lower than that of hard coating materials such as TiN and CrN having wear resistance in the state where lubricating oil does not exist. When the DLC layer is provided on the sliding surface, wear resistance may be improved drastically.

The DLC layer mentioned here is an amorphous hard coating formed of carbon, and comprises both a diamond structure called an SP3 bond and a graphite structure called an SP2 bond as a bonding form of carbon. To form such a DLC layer, it is preferable to use vapor deposition methods such as PVD, CVD, etc. Moreover, when the DLC layer is formed, there is no particular limitation on operating conditions on these vapor deposition methods.

Moreover, the DLC layer thickness is preferable to be in the range of 0.1 μm to 10.0 μm. The DLC layer thickness less than 0.1 μm may not improve wear resistance, and meaning of formation the DLC layer is lost. On the other hand, the DLC layer thickness exceeding 10.0 μm tends to make a part of the DLC layer peeling off because the DLC coating itself is fragile for its hardness. The DLC layer thickness in the range of 1.0 μm to 5.0 μm is more preferable.

In the combination structure of the piston ring and the cylinder liner for the internal combustion engine according to the present invention, both the upper surface of the piston ring and the bottom surface of the piston ring to be settled in a piston ring groove of the piston ring is preferable to comprise a resin coat layer formed by using either of a heat resistant resin or a filler-containing heat resistant resin which a heat resistant resin contains an inorganic filler. The resin coat layer using the heat resistant resin may be provided on the sliding surface of the piston ring directly, or may be provided on the surface of the above-mentioned nitride layer to be a two-layer structure of the nitride layer/the resin coat layer. When the above-mentioned DLC layer is provided on the sliding surface of the piston ring, any layer structure selected from a two-layer structure of the DLC layer/the resin coat layer, the resin coat layer/the DLC layer may be provided, and a three-layered structure of the nitride layer/the resin coat layer/the DLC layer may be acceptable.

Moreover, it is preferable to use either of a polybenzimidazole resin or a polyamide-imide resin having a heat resisting temperature of not less than 150° C. for the heat resistant resin. Here, the reason why the heat resisting temperature is specified at a temperature of not less than 150° C. is that the piston ring contacts engine oil of the internal combustion engine and temperature of the engine oil is usually elevated close to 150° C. in operation of the internal combustion engine for a popular automobile. So, just the resin component bear the temperature can be used. The heat resisting temperature mentioned here means a temperature at which melting and/or remarkable resin softening are hardly occur in an ambient temperature.

Various kinds of resins may satisfy the heat resisting temperature of not less than 150° C. mentioned here. For example, polybenzimidazole (PBI), polyamide-imide (PAI), polyimide (PI), polyether ether ketone (PEEK), polyamide (PA), etc. are included. These resins can be used alone, or not less than two kinds of the resins can be used in combination freely. However, when formation of a uniform coating and durability as a resin are taken into consideration, among the resins, polybenzimidazole (PBI) or polyamide-imide (PAI) is recommended to form the resin coat layer.

Moreover, the heat resistant resin can contain flake-shaped copper powder, molybdenum disulfide (MoS₂) particles, graphite (graphite) particles, and the like that provide the solid lubricating feature added alone or in combination as a filler.

The resin coat layer thickness described above is preferable to be 3 μm to 10 μm. The resin coat layer thickness of less than 3 μm may lose uniformity of the resin film thickness and the resin coat layer tends not applicable in the piston of the internal combustion engine. In contrast, the resin coat layer thickness exceeding 10 μm may tend to show difficulties to obtain uniform contact pressure between the inner circumferential surface of the cylinder liner and the sliding surface of the piston ring.

Quality of the piston ring can be stabilized by properly providing the nitride layer, the DLC layer, and the resin coat layer described so far. As a result, durability of the sliding surface of the piston ring that slide along the cylinder liner is drastically improved, and also, excellent low friction properties, wear resistance properties, and scuffing resistance properties can be achieved.

The combination structures of the cylinder liners and the piston rings mentioned above are based on the assumption using at the contact pressure 0.03 MPa to 0.2 MPa of the piston ring provided on the piston against to the inner circumferential surface of the cylinder liner, i.e. the combination structures of the cylinder liners and the piston rings are suitable for the above-mentioned range of the contact pressure mentioned above. As long as the contact pressure is within the range, life span as an internal combustion engine can be increased and durability thereof can be improved by using the combination structures of the cylinder liners and the piston rings described above. As a result, an internal combustion engine of high quality can be provided. Hereinafter, the present invention will be demonstrated by Examples.

### EXAMPLES

Production of a cylinder liner equivalent material: Molten metal of seven kinds of the aluminum alloy compositions shown in Table 1 were prepared and cylindrical base shapes were formed by a spray-forming method in a nitrogen atmosphere. The cylindrical base shapes were subjected to compressing, drawing, and plastic processing by forging, to produce a cylinder liner equivalent material.

Cylindrical base shapes for a wear test of the cylinder liner equivalent material against to a piston ring described later were formed by using the above-mentioned molten metal comprising seven kinds of compositions by the spray-forming method in the nitrogen atmosphere mentioned above. These cylindrical base shapes were subjected to compressing, drawing, and plastic processing by forging, and a roller shape having an inner diameter of 16 mm, an outer diameter of 40 mm with a thickness of 10 mm that can be pivotally supported by a rotational rotor 6 of a wear tester 5 shown in FIG. 3 was formed. The outer circumferential surface was assumed to be “bore specimen” for the wear test. Specimens for the wear test are referred to as “CL specimen 1”, “CL specimen 2”, “CL specimen 3”, “CL specimen 4”, “CL specimen 5”, “CL specimen 6” and “CL specimen 7”. In the case of “CL specimen 1” shown in Table 1, the specimen was prepared to be the composition, the silicon content of 20.0 mass %, the magnesium content of 0.8 mass %, the copper content of 3.0 mass %, the iron content of 0.15 mass %, the nickel content of 0.01 mass %, and the balance of aluminum and inevitable impurities.

In the case of “CL specimen 2”, the specimen was prepared to be the composition, the silicon content of 23.0 mass %, the magnesium content of 1.2 mass %, the copper content of 3.9 mass %, the iron content of 0.15 mass %, the nickel content of 0.01 mass %, and the balance of aluminum and inevitable impurities.

In the case of “CL specimen 3”, the specimen was prepared to be the composition, the silicon content of 28.0 mass %, the magnesium content of 2.0 mass %, the copper content of 4.5 mass %, the iron content of 0.2 mass %, the nickel content of 0.01 mass %, and the balance of aluminum and inevitable impurities.

In the case of “CL specimen 4”, the specimen was prepared to be the composition, the silicon content of 20.0 mass %, the magnesium content of 0.8 mass %, the copper content of 3.0 mass %, the iron content of 1.0 mass %, the nickel content of 1.0 mass %, and the balance of aluminum and inevitable impurities.

In the case of “CL specimen 5”, the specimen was prepared to be the composition, the silicon content of 23.0 mass %, the magnesium content of 1.2 mass %, the copper content of 3.9 mass %, the iron content of 1.2 mass %, the nickel content of 2.2 mass %, and the balance of aluminum and inevitable impurities.

In the case of “CL specimen 6”, the specimen was prepared to be the composition, the silicon content of 28.0 mass %, the magnesium content of 2.0 mass %, the copper content of 4.5 mass %, the iron content of 1.4 mass %, the nickel content of 5.0 mass %, and the balance of aluminum and inevitable impurities.

In the case of “CL specimen 7”, the specimen was prepared to be the composition, the silicon content of 20.0 mass %, the magnesium content of 0.44 mass %, the copper content of 2.61 mass %, the iron content of 0.59 mass %, the zinc content of 0.01 mass %, the manganese content of 0.01 mass %, the nickel content of 0.01 mass %, the calcium content of 0.003 mass %, the phosphorus content of 0.027 mass %, and the balance of aluminum and inevitable impurities.

Production of the piston ring: In the Examples, three kinds of compositions were prepared for production of the first ring, and specimens each having two levels of surface roughness for each composition were produced (“FR Specimen 1” to “FR Specimen 6”). For “FR Specimen 1” and “FR Specimen 2” shown in Table 3, the base materials which is an austenite stainless steel having a composition of the chromium content of 17.0 mass %, the nickel content of 4.5 mass %, the manganese content of 6.5 mass %, the silicon content of 0.9 mass %, the carbon content of 0.10 mass %, the phosphorus content of 0.02 mass %, the sulfur content of 0.01 mass %, and the balance of iron and inevitable impurities and is gas nitriding treated were used.

For “FR Specimen 3” and “FR Specimen 4” shown in Table 3, the base materials which is an austenite stainless steel having a composition of the chromium content of 19.0 mass %, the nickel content of 9.0 mass %, the manganese content of 1.6 mass %, the silicon content of 0.7 mass %, the carbon content of 0.04 mass %, the phosphorus content of 0.035 mass %, the sulfur content of 0.02 mass %, and the balance of iron and inevitable impurities and is gas nitriding treated were used.

For “FR Specimen 5” and “FR Specimen 6”, the base materials which is an austenite stainless steel having a composition of the chromium content of 17.0 mass %, the nickel content of 12.0 mass %, the manganese content of 1.6 mass %, the silicon content of 0.7 mass %, the carbon content of 0.04 mass %, the phosphorus content of 0.035 mass %, the sulfur content of 0.02 mass %, the molybdenum content of 2.5 mass %, and the balance of iron and inevitable impurities and is gas nitriding treated were used.

The first ring comprises D1 of 90 mm, a1 of 3.3 mm, h1 of 1.2 mm, and S1 of 0.25 mm. In the Examples, six kinds of first rings which satisfy the range of the surface roughness properties 2 were manufactured. The first rings are referred to as “FR Specimen 1”, “FR Specimen 2”, “FR Specimen 3”, “FR Specimen 4”, “FR Specimen 5” and “FR Specimen 6”. Moreover, FIG. 2(a) shows an observed image of a cross sectional view of the nitride layer in “FR Specimen 1” which is obtained by using a metallurgical microscope. FIG. 2(b) shows an observed image of a cross sectional view of the nitride layer in “FR Specimen 3” which is obtained by using a metallurgical microscope. In order to perform the cross-sectional investigation, wear test specimens of the first ring equivalent material having the specification same with “FR Specimen 1” and “FR Specimen 3” were produced (fixed piece: 8 mm×7 mm×5 mm).

Then, a wear test on the piston ring was carried out by using a wear tester shown in FIG. 3 in combination with the above-mentioned “bore specimen”. A “bore specimen 2” having a roller shape was used for wear test with the piston ring material 1. In the test, the piston ring material 1 was pushed on with a load W (784 N) for 7 hours against an upper side of the rotating “bore specimen 2” (outer periphery linear speed of 1 m/sec.) of which bottom half was dipped into an 80° C. lubricating oil 4 (turbine oil #100) in an oil bath 3. The worn amount in both the piston ring material 1 and the “bore specimen 2” after finishing the test was determined. The summary of the wear test is shown in Table 4 below so that the summary can be compared with that of Comparative Examples. The wear test is a substitution test to estimate a wear degree in the respective sliding surfaces of the piston ring and the cylinder liner of an actual internal combustion engine caused by the sliding operation of the piston ring and the cylinder liner.

### Example 1

In Example 1, “the worn amount in the cylinder liner equivalent material”, “the worn amount in the first ring equivalent material” and “total worn amount that is sum of worn amount in both the cylinder liner equivalent material and the first ring equivalent material” were investigated on the seven kinds of the cylinder liner equivalent materials (“CL specimen 1” to “CL specimen 7”) in combination with “FR Specimen 3” in the first ring equivalent material respectively. Example 1 is common in using “FR Specimen 3” as the first ring equivalent material specimen. As is shown in Table 3, “FR Specimen 3” comprises the surface roughness Rz_{JIS94} of 0.7 μm and Rpk of 0.06 μm and the values are low in the range of the surface roughness properties 2. As is shown in Table 4, the worn amounts when “FR Specimen 3” was combined with each cylinder liner equivalent material (“CL specimen 1” to “CL specimen 7”) of Example 1 were “The worn amount in the cylinder liner equivalent material” of 0.41 μm to 0.55 μm (an average value of 0.48 μm), “The worn amount in the first ring equivalent material” of 0.85 μm to 0.95 μm (an average value of 0.90 μm), “total worn amount that is sum of worn amount in both the cylinder liner equivalent material and the first ring equivalent material” of 1.35 μm to 1.41 μm (an average value of 1.38 μm).

### Example 2

In Example 2, “the worn amount in the cylinder liner equivalent material”, “the worn amount in the first ring equivalent material” and “total worn amount that is sum of worn amount in both the cylinder liner equivalent material and the first ring equivalent material” were investigated on the seven kinds in the cylinder liner equivalent materials (“CL specimen 1” to “CL specimen 7”) in combination with “FR Specimen 4” in the first ring equivalent material respectively. Example 2 is common in using the specimen “FR Specimen 4” as the first ring equivalent material. As is shown in Table 3, “FR Specimen 4” comprises the surface roughness Rz_{JIS94} of 1.6 μm and Rpk of 0.3 μm and the values exist close to upper limit in the range of the surface roughness properties 2. As is shown in Table 4, the worn amounts when “FR Specimen 4” was combined with each cylinder liner equivalent material (“CL specimen 1” to “CL specimen 7”) of Example 2 were “The worn amount in the cylinder liner equivalent material” of 0.46 μm to 0.58 μm (an average value of 0.50 μm), “The worn amount in the first ring equivalent material” of 0.87 μm to 0.97 μm (an average value of 0.92 μm), “total worn amount that is sum of worn amount in both the cylinder liner equivalent material and the first ring equivalent material” of 1.40 μm to 1.45 μm (an average value of 1.42 μm).

### Example 3

In Example 3, “the worn amount in the cylinder liner equivalent material”, “the worn amount in the first ring equivalent material” and “total worn amount that is sum of worn amount in both the cylinder liner equivalent material and the first ring equivalent material” were investigated on three kinds in the cylinder liner equivalent materials (“CL specimen 2”, “CL specimen 5” and “CL specimen 7”) in combination with “FR Specimen 1” and “FR Specimen 2” in the first ring equivalent material respectively. In Example 3, the first ring equivalent materials uses were “FR Specimen 1” and “FR Specimen 2”. As shown in Table 3, the nitride layer thickness was 40 μm, and the hardness was 980 HV0.1 in both “FR Specimen 1” and “FR Specimen 2”. When these values are compared to the nitride layer thickness in the range 30 μm to 150 μm and the hardness in the range of 900 HV0.1 to 1200 HV0.1 in the present invention, the thickness and hardness of the nitride layer in “FR Specimen 1” and “FR Specimen 2” exist close to the lower limit. As is shown in Table 4, the worn amounts when “FR Specimen 1” and “FR Specimen 2” were combined with each cylinder liner equivalent material (“CL specimen 2”, “CL specimen 5” and “CL specimen 7”) of Example 3 were, “The worn amount in the cylinder liner equivalent material” of 0.46 μm to 0.57 μm (an average value of 0.50 μm), “The worn amount in the first ring equivalent material” of 0.86 μm to 0.95 μm (an average value of 0.92 μm), “total worn amount that is sum of worn amount in both the cylinder liner equivalent material and the first ring equivalent material” was 1.39 μm to 1.45 μm (an average value of 1.42 μm).

### Example 4

In Example 4, “the worn amount in the cylinder liner equivalent material”, “the worn amount in the first ring equivalent material” and “total worn amount that is sum of worn amount in both the cylinder liner equivalent material and the first ring equivalent material” were investigated on the three kinds in the cylinder liner equivalent materials (“CL specimen 2”, “CL specimen 5” and “CL specimen 7”) in combination with “FR Specimen 5” and “FR Specimen 6” in the first ring equivalent material respectively. In Example 4, the first ring equivalent materials used are “FR Specimen 5” and “FR Specimen 6”. As shown in Table 3, the nitride layer thickness was 130 μm, and the hardness was 1080 HV0.1 in both “FR Specimen 5” and “FR Specimen 6”. When these values are compared to the nitride layer thickness in the range of 30 μm to 150 μm and the hardness thereof is within the range of 900 HV0.1 to 1200 HV0.1 in the present invention, the thickness and hardness of the nitride layer in “FR Specimen 5” and “FR Specimen 6” exists close to the upper limit. As is shown in Table 4, the worn amounts when “FR Specimen 5” and “FR Specimen 6” were combined with each cylinder liner equivalent material (“CL specimen 2”, “CL specimen 5” and “CL specimen 7”) of Example 4 were, “The worn amount in the cylinder liner equivalent material” of 0.46 μm to 0.59 μm (an average value of 0.52 μm), “The worn amount in the first ring equivalent material” of 0.83 μm to 0.92 μm (an average value of 0.89 μm), “total worn amount that is sum of worn amount in both the cylinder liner equivalent material and the first ring equivalent material” was 1.36 μm to 1.45 μm (an average value of 1.40 μm).

Moreover, a fatigue test was carried out on the piston ring independently. In the fatigue test, an abutment portion was oscillated at 2000 rpm while a specified stress was applied. Then, an S—N curve was obtained from this result. The summary of the fatigue test is shown in a graph of FIG. 4 so that “FR Specimen 1”, “FR Specimen 3” and “FR Specimen 5” of Examples can be compared with “FR Comparative Specimen A” and “FR Comparative Specimen B” of Comparative Example 5.

### Comparison Between Example 1 and Example 2

In comparison between Example 1 and Example 2 made on the summary described in Table 4, Example 2 using the first ring equivalent material having a higher level surface roughness show a slightly larger value in all of “the worn amount in the cylinder liner equivalent material”, “the worn amount in the first ring equivalent material”, and “total worn amount that is sum of worn amount in both the cylinder liner equivalent material and the first ring equivalent material”. However, all of “total worn amount that is sum of worn amount in both the cylinder liner equivalent material and the first ring equivalent material” is not more than 1.45 μm in Example 2. It is made clear that, in the combination structure of the cylinder liner and the first ring, there is no influence in durability performance as long as the combination structure satisfies the conditions of the present invention.

### Comparison Between Example 3 and Example 4

In comparison between Example 3 and Example 4 made on the summary described in Table 4, Example 4 using the nitride layer in the first ring equivalent material having a higher level hardness showed a slightly larger value of “the worn amount in the cylinder liner equivalent material” and a slightly smaller value of “the worn amount in the first ring equivalent material”. “Total worn amount that is sum of worn amount in both the cylinder liner equivalent material and the first ring equivalent material” was approximately the same value in Example 3 and Example 4. From the summary, it is made clear that harder the nitride layer in the first ring equivalent material, the attack to the cylinder liner equivalent material is made larger. However, “total worn amount that is sum of worn amount in both the cylinder liner equivalent material and the first ring equivalent material” is not more than 1.45 μm in each combination structure. It is made clear that, in the combination structures of the cylinder liner and the first ring, there is no influence in durability performance as long as the combination structure satisfies the conditions of the present invention.

Comparison between “FR Specimen 3” of Example and “FR Specimen 5” of Example: As shown in Table 3, in “FR Specimen 5”, the chromium content is slightly reduced, the nickel content is increased, and further molybdenum is added against to “FR Specimen 3”. Moreover, the surface roughness is Rz_{JIS94} of 0.7 μm and Rpk of 0.06 μm in “FR Specimen 3”, Rz_{JIS94} of 0.8 μm and Rpk of 0.08 μm in “FR Specimen 5” and is approximately the same conditions. The hardness of the nitride layer is also 1050 HV0.1 in “FR Specimen 3” and 1080 HV in “FR Specimen 5” and is approximately the same conditions. Table 4 shows a test results carried out an Amsler type wear test on “FR Specimen 3” (see Example 1.) and “FR Specimen 5” (see Example 4.), respectively. The summaries of the comparison among “CL specimen 2”, “CL specimen 5” and “CL specimen 7” as the specimen common in Example 1 and Example 4 for the cylinder liner equivalent material, “the worn amount in the cylinder liner equivalent material” was an average value of 0.49 μm in “FR Specimen 3” (0.48 μm in CL specimen 2, 0.44 μm in CL specimen 5, and 0.55 μm in CL specimen 7). In contrast, “the worn amount as an average value in the cylinder liner equivalent material” was 0.50 μm in “FR Specimen 5” (0.49 μm in CL specimen 2, 0.46 μm in CL specimen 5, and 0.56 μm in CL specimen 7).

In the comparison between “the worn amount in the first ring equivalent material” and “FR Specimen 3” and “FR Specimen 5”, an average value of “the worn amount in the first ring equivalent material” was 0.90 μm for “FR Specimen 3” (0.92 μm in CL specimen 2, 0.92 μm in CL specimen 5, and 0.85 μm in CL specimen 7). In contrast, an average value of “the worn amount in the first ring equivalent material” was 0.88 μm in “FR Specimen 5” (0.91 μm in CL specimen 2, 0.90 μm in CL specimen 5, and 0.83 μm in CL specimen 7).

An average value of “total worn amount that is sum of worn amount in both the cylinder liner equivalent material and the first ring equivalent material” is 1.39 μm for “FR Specimen 3” (1.40 μm in CL specimen 2, 1.36 μm in CL specimen 5, and 1.40 μm in CL specimen 7), and 1.38 μm for “FR Specimen 5” (1.40 μm in CL specimen 2, 1.36 μm in CL specimen 5, and 1.39 μm in CL specimen 7).

In the comparison between “FR Specimen 3” and “FR Specimen 5” on the worn amount, wear resistance properties obtained was approximately equal. Also in the fatigue test as shown in FIG. 4, a cyclic stress after 1×10⁷ cycles was 1030 MPa in both “FR Specimen 3” and “ER specimen 5”, i.e. fatigue strength properties obtained were almost equal. The summary shows that even when “FR Specimen 3” is slightly reduced in the chromium content, is increased in the nickel content, and further is added of molybdenum, approximately equal wear resistance properties and fatigue strength properties can be maintained.

Comparison between “CL specimen 1” and “CL specimen 7”: A result of comparison between “CL specimen 1” and “CL specimen 7” of Example 1 and Example 2 shown in Table 4 will be described below. Here, “CL specimen 1” is different from “CL specimen 7” as follows. “CL specimen 7” has a composition in which the content of magnesium is close to the lower limit in the range in the alloy composition for a cylinder liner 1 according to the present invention, and the content of iron is close to the upper limit in the range in the alloy composition for a cylinder liner 1 according to the present invention. In the Example 1 disclosed in the Table 4, the worn amounts were compared in combination structures of the common first ring equivalent material “FR Specimen 3” and the cylinder liner equivalent materials of “CL specimen 1” and “CL specimen 7”. “the worn amount in the cylinder liner equivalent material” were 0.51 μm in “CL specimen 1” and 0.55 μm in “CL specimen 7”, “The worn amount in the first ring equivalent material” were 0.87 μm in “CL specimen 1” and 0.85 μm in “CL specimen 7”, “total worn amount that is sum of worn amount in both the cylinder liner equivalent material and the first ring equivalent material” were 1.38 μm in “CL specimen 1” and 1.40 μm in “CL specimen 7”.

Next, worn amounts will be compared in Example 2 of Table 4. The common first ring equivalent material “FR Specimen 4” was combined with each cylinder liner equivalent material of “CL specimen 1” and “CL specimen 7” respectively. “The worn amount in the cylinder liner equivalent material” was 0.52 μm in “CL specimen 1” and 0.58 μm in “CL specimen 7”. “The worn amount in the first ring equivalent material” was 0.89 μm in “CL specimen 1” and 0.87 μm in “CL specimen 7”. “total worn amount that is sum of worn amount in both the cylinder liner equivalent material and the first ring equivalent material” was 1.41 μm in “CL specimen 1” and 1.45 μm in “CL specimen 7”.

According to the above-mentioned result, in comparison between “CL specimen 1” and “CL specimen 7” on the composition that the cylinder liner, it is made obvious that when the content of magnesium is close to the lower limit in the range in the alloy composition for a cylinder liner 1 according to the present invention, and the content of iron is close to the upper limit in the range in the alloy composition for a cylinder liner 1 according to the present invention, the wear resistance performance in the cylinder liner might be slightly reduced.

### COMPARATIVE EXAMPLES

The cylinder liner equivalent material used in Comparative Examples was manufactured by the same procedure as that of Examples using the alloy composition shown in Table 2 below and in addition, honing was performed on the inner circumferential surface of the cylinder liner equivalent material followed by contacting with a caustic soda solution for 30 seconds for chemical polishing and then polished to adjust the surface roughness (RK, Rpk, Rvk). In the chemical polishing, 3.5 L of a 5.0 wt % caustic soda solution with solution temperature of 50±3° C. was used for one cylinder as the chemical polishing solution. It should be clearly stated here that in the case of the “bore specimen” for the wear test, the chemical polishing treatment is performed on the outer circumferential surface.

### Comparative Example 1

In Comparative Example 1, examination was carried out for “the worn amount in the cylinder liner equivalent material”, “the worn amount in the first ring equivalent material”, and “total worn amount that is sum of worn amount in both the cylinder liner equivalent material and the first ring equivalent material” on the seven kinds of cylinder liner equivalent materials (“CL Comparative Specimen a” to “CL Comparative Specimen g”) shown in Table 2 in combination with “FR Specimen 3” the common first ring equivalent material used in Examples mentioned above. In Comparative Example 1 is common in using the specimen “FR Specimen 3” as the first ring equivalent material. As is shown in Table 3, the surface roughness of “FR Specimen 3” is Rz_{JIS94} of 0.7 μm and Rpk of 0.06 μm, and is a relatively smaller surface roughness when compared to the range of the surface roughness properties 2. As is shown in Table 5, the worn amounts when “FR Specimen 3” was combined with each cylinder liner equivalent material of Comparative Example 1 will be described. “The worn amount in the cylinder liner equivalent material” was 0.41 μm to 0.61 μm (an average value of 0.55 μm). “The worn amount in the first ring equivalent material” was 0.90 μm to 1.10 μm (an average value of 0.95 μm). “Total worn amount that is sum of worn amount in both the cylinder liner equivalent material and the first ring equivalent material” was 1.47 μm to 1.55 μm (an average value of 1.50 μm).

### Comparative Example 2

In Comparative Example 2, examination was carried out for “the worn amount in the cylinder liner equivalent material”, “the worn amount in the first ring equivalent material” and “total worn amount that is sum of worn amount in both the cylinder liner equivalent material and the first ring equivalent material” on the seven kinds of cylinder liner equivalent materials (“CL Comparative Specimen a” to “CL Comparative Specimen g”) shown in Table 2 in combination with “FR Specimen 4” in the first ring equivalent material used in Examples mentioned above. Comparative Example 2 is common in using the specimen of “FR Specimen 4” as the first ring equivalent material. As is shown in Table 3, the surface roughness of “FR Specimen 4” is Rz_{JIS94} of 1.6 μm and Rpk of 0.3 μm, and is large and close to the upper limit when compared to the range of the surface roughness properties 2. As is shown in Table 5, the worn amounts when “FR Specimen 4” was combined with each cylinder liner equivalent material of Comparative Example 2 will be described. “The worn amount in the cylinder liner equivalent material” was 0.44 μm to 0.61 μm (an average value of 0.55 μm). “The worn amount in the first ring equivalent material” was 0.92 μm to 1.11 μm (an average value of 0.97 μm). “Total worn amount that is sum of worn amount in both the cylinder liner equivalent material and the first ring equivalent material” was 1.46 μm to 1.58 μm (an average value of 1.53 μm).

### Comparative Example 3

In Comparative Example 3, examination was carried out for “the worn amount in the cylinder liner equivalent material”, “the worn amount in the first ring equivalent material” and “total worn amount that is sum of worn amount in both the cylinder liner equivalent material and the first ring equivalent material” on two kinds of cylinder liner equivalent materials (“CL Comparative Specimen b” and “CL Comparative Specimen c”) shown in Table 2 in combination with “FR Specimen 1” and “FR Specimen 2” in the first ring equivalent material used in Examples mentioned above. The first ring equivalent materials used in Comparative Example 3 are “FR Specimen 1” and “FR Specimen 2” formed with the nitride layer thickness of 40 μm and the hardness is 980 HV0.1 as shown in Table 3. When the nitride layer thickness within the range of 30 μm to 150 μm and the hardness thereof is within the range of 900 HV0.1 to 1200 HV0.1 in the present invention is considered, the thickness and hardness of the nitride layer in “FR Specimen 1” and “FR Specimen 2” are close to the lower limit. As is shown in Table 5, the worn amounts when “FR Specimen 1” and “FR Specimen 2” were combined with each cylinder liner equivalent material of Comparative Example 3 will be described. “The worn amount in the cylinder liner equivalent material” was 0.55 μm to 0.60 μm (an average value of 0.58 μm). “The worn amount in the first ring equivalent material” was 0.93 μm to 0.99 μm (an average value of 0.96 μm). “Total worn amount that is sum of worn amount in both the cylinder liner equivalent material and the first ring equivalent material” was 1.48 μm to 1.58 μm (an average value of 1.54 μm).

### Comparative Example 4

In Comparative Example 4, examination was carried out for “the worn amount in the cylinder liner equivalent material”, “the worn amount in the first ring equivalent material” and “total worn amount that is sum of worn amount in both the cylinder liner equivalent material and the first ring equivalent material” on two kinds of cylinder liner equivalent materials (“CL Comparative Specimen e” and “CL Comparative Specimen f”) shown in Table 2 in combination with “FR Specimen 5” and “FR Specimen 6” in the first ring equivalent material used in Examples mentioned above. The first ring equivalent material used in Comparative Example 4 were “FR Specimen 5” and “FR Specimen 6” formed with the nitride layer thickness of 130 μm, and the hardness is 1080 HV0.1 as shown in Table 3. When the nitride layer thickness within the range of 30 μm to 150 μm and the hardness thereof is within the range of 900 HV0.1 to 1200 HV0.1 in the present invention is considered, the thickness and hardness of the nitride layer in “FR Specimen 5” and “FR Specimen 6” are close to the upper limit. According to Table 5, worn amounts in “FR Specimen 5” and “FR Specimen 6” both combined with each cylinder liner equivalent materials of Comparative Example 4 are as follows. “The worn amount in the cylinder liner equivalent material” was 0.56 μm to 0.59 μm (an average value of 0.57 μm). “The worn amount in the first ring equivalent material” was 0.90 μm to 0.96 μm (an average value of 0.93 μm). “Total worn amount that is sum of worn amount in both the cylinder liner equivalent material and the first ring equivalent material” was 1.46 μm to 1.55 μm (an average value of 1.51 μm).

### Comparative Example 5

In Comparative Example 5, examination was carried out for “the worn amount in the cylinder liner equivalent material”, “the worn amount in the first ring equivalent material” and “total worn amount that is sum of worn amount in both the cylinder liner equivalent material and the first ring equivalent material” on two kinds of cylinder liner equivalent materials (“CL specimen 2” and “CL specimen 5”) used in Examples shown in Table 1 in combination with “FR Comparative Specimen C” having the same composition with the first ring equivalent material “FR Comparative Specimen A” or “FR Comparative Specimen B” used in Comparative Examples shown in Table 3 and the first ring equivalent materials “FR Specimen 3” and “FR Specimen 4” used in Examples, and having the surface roughness exceeding the range of the surface roughness properties 2.

First, examination was carried out on the case where “CL specimen 2” in combination with “FR Comparative Specimen A” or “FR Comparative Specimen B”. “FR Comparative Specimen A” (SUS410J1 equivalent material) and “FR Comparative Specimen B” (SUS440B equivalent material) both have a composition different from that of the present invention, and are martensite stainless steel having an increased carbon content. Also, the hardness of the nitride layer is close to the upper limit of the range in the present invention.

As is shown in Table 5, worn amount in “FR Comparative Specimen A” in combination with “CL specimen 2” will be described. “The worn amount in the cylinder liner equivalent material” was 0.82 μm, “the worn amount in the first ring equivalent material” was 0.69 μm, and “total worn amount that is sum of worn amount in both the cylinder liner equivalent material and the first ring equivalent material” was 1.51 μm.

On the other hand, worn amounts in “FR Comparative Specimen B” in combination with “CL specimen 2” will be described. “The worn amount in the cylinder liner equivalent material” was 1.15 μm, “the worn amount in the first ring equivalent material” was 0.40 μm, and “total worn amount that is sum of worn amount in both the cylinder liner equivalent material and the first ring equivalent material” was 1.55 μm.

Then, “worn amount in FR Comparative Specimen C” when combined with “CL specimen 5” will be described. “The worn amount in the cylinder liner equivalent material” was 0.60 μm, “the worn amount in the first ring equivalent material” was 1.18 μm, and “total worn amount that is sum of worn amount in both the cylinder liner equivalent material and the first ring equivalent material” was 1.78 μm.

FIG. 5(a) shows an observed image of a cross section obtained by a metallurgical microscope when the nitride layer is formed on “FR Comparative Specimen A”. FIG. 5(b) shows an observed image of a cross section obtained by a metallurgical microscope when the nitride layer is formed on “FR Comparative Specimen B”.

Comparison between “CL Comparative Specimen a” and “CL Comparative Specimen d” used in Comparative Example 1 and Comparative Example 2: A result of comparison between “CL Comparative Specimen a” and “CL Comparative Specimen d” used in Comparative Example 1 and Comparative Example 2 shown in Table 5 will be described below. The silicon content and the magnesium content of “CL Comparative Specimen a” are respectively smaller than the lower limit in the range of the present invention, and the silicon content and the magnesium content of “CL Comparative Specimen d” are respectively larger than the upper limit in the range of the present invention. In a comparison on the worn amount between “CL Comparative Specimen a” and “CL Comparative Specimen d” disclosed in Table 5, “the worn amount in the cylinder liner equivalent material” was 0.60 μm and 0.61 μm in “CL Comparative Specimen a” and 0.41 μm and 0.44 μm in “CL Comparative Specimen d”. “The worn amount in the first ring equivalent material” was 0.90 μm and 0.92 μm in “CL Comparative Specimen a” and 1.10 μm and 1.11 μm in “CL Comparative Specimen d”. Values “total worn amount that is sum of worn amount in both the cylinder liner equivalent material and the first ring equivalent material” in “CL Comparative Specimen a” were 1.50 μm and 1.53 μm and 1.51 μm and 1.55 μm in “CL Comparative Specimen d”.

According to the above-mentioned result, in “CL Comparative Specimen a” in which both the silicon content and the magnesium content are small, both crystallization of primary crystal grains of pro-eutectic silicon which performs the solid lubricating feature and formation of Mg₂Si which is an intermetallic compound which performs the solid lubricating feature formed with magnesium and silicon are insufficient. In addition, pro-eutectic silicon contained after solidification in the aluminum matrix of “CL Comparative Specimen d” might be too large and excessive matrix hardness was provided by high dispersion density.

Comparison between “CL Comparative Specimen b” and “CL Comparative Specimen c” used in Comparative Example 1 and Comparative Example 2: In comparison between “CL Comparative Specimen b” and “CL Comparative Specimen c” used in Comparative Example 1 and Comparative Example 2 shown in Table 5 will be described below. Composition of “CL Comparative Specimen b” and “CL Comparative Specimen c” were included in the alloy composition for a cylinder liner 1. And the common first ring equivalent material (“FR Specimen 3” or “FR Specimen 4”) was also used. Difference in “CL Comparative Specimen b” and “CL Comparative Specimen c” is that the surface roughness of “CL Comparative Specimen b” is larger than the upper limit in the range of the surface roughness properties 1, and the surface roughness of “CL Comparative Specimen c” is smaller than the lower limit in the range of the surface roughness properties 1. In comparison on the worn amount between “CL Comparative Specimen b” and “CL Comparative Specimen c” in Comparative Example 1 as shown in Table 5 above, “the worn amount in the cylinder liner equivalent material” was 0.61 μm in “CL Comparative Specimen b” and 0.56 μm in “CL Comparative Specimen c”. “The worn amount in the first ring equivalent material” was 0.94 μm in “CL Comparative Specimen b” and 0.92 μm in “CL Comparative Specimen c”. “Total worn amount that is sum of worn amount in both the cylinder liner equivalent material and the first ring equivalent material” was 1.55 μm in “CL Comparative Specimen b” and 1.48 μm in “CL Comparative Specimen c”.

Next, in the comparison on the worn amount between “CL Comparative Specimen b” and “CL Comparative Specimen c” in Comparative Example 2 shown in Table 5, “the worn amount in the cylinder liner equivalent material” was 0.60 μm in “CL Comparative Specimen b” and 0.57 μm in “CL Comparative Specimen c”. “The worn amount in the first ring equivalent material” was 0.98 μm in “CL Comparative Specimen b” and 0.96 μm in “CL Comparative Specimen c”. “Total worn amount that is sum of worn amount in both the cylinder liner equivalent material and the first ring equivalent material” was 1.58 μm in “CL Comparative Specimen b” and 1.53 μm in “CL Comparative Specimen c”.

According to the above-mentioned result, durability is made poor when the surface roughness in the cylinder liner is out of the range of the surface roughness properties. The similar tendency was obtained also when comparing the worn amounts of “CL Comparative Specimen e” and “CL Comparative Specimen f” in Comparative Example 1 and Comparative Example 2 that both have the same composition as the alloy composition for a cylinder liner 2 and whose surface roughness is higher or lower level out from the range of the surface roughness properties 1.

Comparison between “CL Comparative Specimen c” and “CL Comparative Specimen f” in Comparative Example 1 and Comparative Example 2: A result of comparison between “CL Comparative Specimen c” and “CL Comparative Specimen f” in Comparative Example 1 and Comparative Example 2 shown in Table 5 will be described below. Here, both of “CL Comparative Specimen c” and “CL Comparative Specimen f” have the same surface roughness, and the same first ring equivalent material (“FR Specimen 3” or “FR Specimen 4”) was used. Difference of “CL Comparative Specimen c” from “CL Comparative Specimen f” was that “CL Comparative Specimen c” was made of the alloy composition for a cylinder liner 1 and “CL Comparative Specimen f” was made of the alloy composition for a cylinder liner 2. In comparison on the worn amount between “CL Comparative Specimen c” and “CL Comparative Specimen f” in Comparative Example 1 as shown in Table 5, “the worn amount in the cylinder liner equivalent material” was 0.56 μm in “CL Comparative Specimen c” and 0.55 μm in “CL Comparative Specimen f”. “The worn amount in the first ring equivalent material” was 0.92 μm in both “CL Comparative Specimen c” and “CL Comparative Specimen f”. “Total worn amount that is sum of worn amount in both the cylinder liner equivalent material and the first ring equivalent material” was 1.48 μm in “CL Comparative Specimen c” and 1.47 μm in “CL Comparative Specimen f”.

Next, in comparison on the worn amount in “CL Comparative Specimen c” and “CL Comparative Specimen f” in Comparative Example 2 shown in Table 5, “the worn amount in the cylinder liner equivalent material” was 0.57 μm in “CL Comparative Specimen c” and 0.54 μm in “CL Comparative Specimen f”. “The worn amount in the first ring equivalent material” was 0.96 μm in “CL Comparative Specimen c” and 0.95 μm in “CL Comparative Specimen f”. “Total worn amount that is sum of worn amount in both the cylinder liner equivalent material and the first ring equivalent material” was 1.53 μm in “CL Comparative Specimen c” and 1.49 μm in “CL Comparative Specimen f”.

According to the above-mentioned result, as long as the first ring equivalent material equivalent to “FR Specimen 3” or “FR Specimen 4” is used, just the differences of the composition between the alloy composition for a cylinder liner 1 and the alloy composition for a cylinder liner 2 according to the present invention may not cause difference in an worn amount, namely, “the worn amount in the cylinder liner equivalent material”, “the worn amount in the first ring equivalent material” and “total worn amount that is sum of worn amount in both the cylinder liner equivalent material and the first ring equivalent material”, i.e. an influence on durability performance is almost same.

TABLE 1

| | Alloy | | | | | |
|---|---|---|---|---|---|---|
| | composition* | | Surface roughness properties (μm)** | | | |
| Specimen | Mass % | | Rz_{JIS94} | Rk | Rpk | Rvk |
| CL specimen 1 | Si | 20.0 | 0.77 | 0.28 | 0.07 | 0.1 |
| | Mg | 0.8 | | | | |
| | Cu | 3.0 | | | | |
| | Fe | 0.15 | | | | |
| | Ni | 0.01 | | | | |
| CL specimen 2 | Si | 23.0 | 0.75 | 0.26 | 0.07 | 0.08 |
| | Mg | 1.2 | | | | |
| | Cu | 3.9 | | | | |
| | Fe | 0.15 | | | | |
| | Ni | 0.01 | | | | |
| CL specimen 3 | Si | 28.0 | 0.82 | 0.29 | 0.08 | 0.09 |
| | Mg | 2.0 | | | | |
| | Cu | 4.5 | | | | |
| | Fe | 0.2 | | | | |
| | Ni | 0.01 | | | | |
| CL specimen 4 | Si | 20.0 | 0.78 | 0.27 | 0.07 | 0.08 |
| | Mg | 0.8 | | | | |
| | Cu | 3.0 | | | | |
| | Fe | 1.0 | | | | |
| | Ni | 1.0 | | | | |
| CL specimen 5 | Si | 23.0 | 0.85 | 0.28 | 0.08 | 0.12 |
| | Mg | 1.2 | | | | |
| | Cu | 3.9 | | | | |
| | Fe | 1.2 | | | | |
| | Ni | 2.2 | | | | |
| CL specimen 6 | Si | 28.0 | 0.81 | 0.26 | 0.06 | 0.08 |
| | Mg | 2.0 | | | | |
| | Cu | 4.5 | | | | |
| | Fe | 1.4 | | | | |
| | Ni | 5.0 | | | | |
| CL specimen 7 | Si | 20.0 | 0.71 | 0.26 | 0.05 | 0.08 |
| | Mg | 0.44 | | | | |
| | Cu | 2.61 | | | | |
| | Fe | 0.59 | | | | |
| | Zn | 0.01 | | | | |
| | Mn | 0.01 | | | | |
| | Ni | 0.01 | | | | |
| | Ca | 0.003 | | | | |
| | P | 0.027 | | | | |

*Alloy composition: Alloy composition for a cylinder liner (balance: Al and inevitable impurities).
**Rz_{JIS94}: Ten-point height of roughness profile provided in JIS B 0601 (1994)
Rk: Core roughness depth provided in DIN 4776
Rpk: Reduced peak height provided in DIN 4776
Rvk: Reduced valley depths provided in DIN 4776

TABLE 2

| | Alloy | | | | | |
|---|---|---|---|---|---|---|
| | composition* | | Surface roughness properties (μm)** | | | |
| Specimen | Mass % | | Rz_{JIS94} | Rk | Rpk | Rvk |
| CL Comparative | Si | 18.0 | 0.77 | 0.27 | 0.07 | 0.08 |
| specimen a | Mg | 0.7 | | | | |
| | Cu | 2.0 | | | | |
| | Fe | 0.15 | | | | |
| | Ni | 0.01 | | | | |
| CL Comparative | Si | 23.0 | 3.35 | 0.89 | 0.23 | 0.47 |
| specimen b | Mg | 1.2 | | | | |
| | Cu | 3.9 | | | | |
| CL Comparative | Fe | 0.15 | 0.4 | 0.1 | 0.03 | 0.05 |
| specimen c | Ni | 0.01 | | | | |
| | Zn | 0.01 | | | | |
| CL Comparative | Si | 29.0 | 0.82 | 0.29 | 0.08 | 0.09 |
| specimen d | Mg | 2.5 | | | | |
| | Cu | 5.0 | | | | |
| | Fe | 1.4 | | | | |
| | Ni | 5.0 | | | | |
| | Zn | 0.01 | | | | |
| CL Comparative | Si | 23.0 | 4.12 | 1.06 | 0.3 | 0.52 |
| specimen e | Mg | 1.2 | | | | |
| | Cu | 3.9 | | | | |
| CL Comparative | Fe | 1.2 | 0.4 | 0.1 | 0.03 | 0.05 |
| specimen f | Ni | 2.2 | | | | |
| | Zn | 0.01 | | | | |
| CL Comparative | Si | 23.0 | 0.86 | 0.3 | 0.08 | 0.13 |
| specimen g | Mg | 1.2 | | | | |
| | Cu | 3.9 | | | | |
| | Fe | 1.6 | | | | |
| | Ni | 6.0 | | | | |
| | Zn | 0.01 | | | | |

*Alloy composition: Alloy composition for a cylinder liner (balance: Al and inevitable impurities).
**Rz_{JIS94}: Ten-point height of roughness profile provided in JIS B 0601 (1994)
Rk: Core roughness depth provided in DIN 4776
Rpk: Reduced peak height provided in DIN 4776
Rvk: Reduced valley depths provided in DIN 4776

TABLE 3

| | Alloy | | Nitride layer** | | Surface roughness | |
|---|---|---|---|---|---|---|
| | composition* | | Thickness | Hardness | properties 2 (μm)*** | |
| Specimen | Mass % | | (μm) | (HV0.1) | Rz_{JIS94} | Rpk |
| FR Specimen 1 | Cr | 17.0 | 40 | 980 | 0.75 | 0.07 |
| | Ni | 4.5 | | | | |
| | Mn | 6.5 | | | | |
| | Si | 0.9 | | | | |
| FR Specimen 2 | C | 0.1 | | | 1.55 | 0.26 |
| | P | 0.02 | | | | |
| | S | 0.01 | | | | |
| FR Specimen 3 | Cr | 19.0 | 80 | 1050 | 0.07 | 0.06 |
| | Ni | 9.0 | | | | |
| | Mn | 1.6 | | | | |
| | Si | 0.7 | | | | |
| FR Specimen 4 | C | 0.04 | | | 1.6 | 0.3 |
| | P | 0.035 | | | | |
| | S | 0.02 | | | | |
| FR Specimen 5 | Cr | 17.0 | 130 | 1080 | 0.8 | 0.08 |
| | Ni | 12.0 | | | | |
| | Mn | 1.6 | | | | |
| | Si | 0.7 | | | | |
| FR Specimen 6 | C | 0.04 | | | 1.5 | 0.23 |
| | P | 0.035 | | | | |
| | S | 0.02 | | | | |
| | Mo | 2.5 | | | | |
| FR Comparative | Cr | 13.5 | 80 | 1150 | 0.74 | 0.07 |
| Specimen A | C | 0.66 | | | | |
| (Equivalent to | Si | 0.42 | | | | |
| SUS410J1) | Mn | 0.36 | | | | |
| | P | 0.02 | | | | |
| | S | 0.02 | | | | |
| FR Comparative | Cr | 17.5 | | 1200 | 0.86 | 0.08 |
| Specimen B | Mo | 1.15 | | | | |
| (Equivalent to | C | 0.88 | | | | |
| SUS440B) | V | 0.12 | | | | |
| | Si | 0.42 | | | | |
| | Mn | 0.37 | | | | |
| | P | 0.02 | | | | |
| | S | 0.02 | | | | |

| | | | | |
|---|---|---|---|---|
| FR Comparative | same as FR | 1050 | 1.7 | 0.36 |
| Specimen C | Specimen 2 | | | |

*Alloy composition: Alloy composition for a piston ring (balance: Fe and inevitable impurities).
**Nitriding treatment: Measured value of the nitride layer provided on the sliding surface of the piston ring.
***Rz_{JIS94}: Ten-point height of roughness profile provided in JIS B 0601 (1994)
Rpk: Reduced peak height provided in DIN 4776

TABLE 4

| | Combination of specimens | | | | |
|---|---|---|---|---|---|
| | for wear test | | Worn amounts (μm) | | |
| | Bore specimen¹⁾ | Ring specimen²⁾ | CL³⁾ | FR⁴⁾ | Total⁵⁾ |
| Example 1 | CL specimen 1 | FR Specimen 3 | 0.51 | 0.87 | 1.38 |
| | CL specimen 2 | (Lower limit of | 0.48 | 0.92 | 1.40 |
| | CL specimen 3 | roughness) | 0.46 | 0.95 | 1.41 |
| | CL specimen 4 | | 0.48 | 0.88 | 1.36 |
| | CL specimen 5 | | 0.44 | 0.92 | 1.36 |
| | CL specimen 6 | | 0.41 | 0.94 | 1.35 |
| | CL specimen 7 | | 0.55 | 0.85 | 1.40 |
| Example 2 | CL specimen 1 | FR Specimen 4 | 0.52 | 0.89 | 1.41 |
| | CL specimen 2 | (Upper limit of | 0.50 | 0.94 | 1.44 |
| | CL specimen 3 | roughness) | 0.49 | 0.95 | 1.44 |
| | CL specimen 4 | | 0.50 | 0.90 | 1.40 |
| | CL specimen 5 | | 0.48 | 0.92 | 1.40 |
| | CL specimen 6 | | 0.46 | 0.97 | 1.43 |
| | CL specimen 7 | | 0.58 | 0.87 | 1.45 |
| Example 3 | CL specimen 2 | FR Specimen 1 | 0.47 | 0.93 | 1.40 |
| | CL specimen 2 | FR Specimen 2 | 0.49 | 0.95 | 1.44 |
| | CL specimen 5 | FR Specimen 1 | 0.49 | 0.95 | 1.44 |
| | CL specimen 5 | FR Specimen 2 | 0.46 | 0.93 | 1.39 |
| | CL specimen 7 | FR Specimen 1 | 0.54 | 0.86 | 1.40 |
| | CL specimen 7 | FR Specimen 2 | 0.57 | 0.88 | 1.45 |
| Example 4 | CL specimen 2 | FR Specimen 5 | 0.49 | 0.91 | 1.40 |
| | CL specimen 2 | FR Specimen 6 | 0.51 | 0.92 | 1.43 |
| | CL specimen 5 | FR Specimen 5 | 0.46 | 0.90 | 1.36 |
| | CL specimen 5 | FR Specimen 6 | 0.49 | 0.90 | 1.39 |
| | CL specimen 7 | FR Specimen 5 | 0.56 | 0.83 | 1.39 |
| | CL specimen 7 | FR Specimen 6 | 0.59 | 0.86 | 1.45 |

¹⁾Bore specimen: Aluminum alloy material used for formation in the cylinder liner equivalent material
²⁾Ring material: Stainless steel used for formation in the first ring equivalent material and subjected to nitriding treatment
³⁾Worn amount of CL: Worn amount on the side in the cylinder liner equivalent material
⁴⁾Worn amount of FR: Worn amount on the side in the first ring equivalent material
⁵⁾Total worn amount: (Worn amount of CL) + (Worn amount of FR)

TABLE 5

| | Combination of specimens | | | | |
|---|---|---|---|---|---|
| | for wear test | | Worn amounts (μm) | | |
| | Bore specimen¹⁾ | Ring material²⁾ | CL³⁾ | FR⁴⁾ | Total⁵⁾ |
| Comparative | CL Comparative specimen a | FR Specimen 3 | 0.60 | 0.90 | 1.50 |
| Example 1 | CL Comparative specimen b | | 0.61 | 0.94 | 1.55 |
| | CL Comparative specimen c | | 0.56 | 0.92 | 1.48 |
| | CL Comparative specimen d | | 0.41 | 1.10 | 1.51 |
| | CL Comparative specimen e | | 0.58 | 0.92 | 1.50 |
| | CL Comparative specimen f | | 0.55 | 0.92 | 1.47 |
| | CL Comparative specimen g | | 0.53 | 0.94 | 1.47 |
| Comparative | CL Comparative specimen a | FR Specimen 4 | 0.61 | 0.92 | 1.53 |
| Example 2 | CL Comparative specimen b | | 0.60 | 0.98 | 1.58 |
| | CL Comparative specimen c | | 0.57 | 0.96 | 1.53 |
| | CL Comparative specimen d | | 0.44 | 1.11 | 1.55 |
| | CL Comparative specimen e | | 0.58 | 0.97 | 1.55 |
| | CL Comparative specimen f | | 0.54 | 0.95 | 1.49 |
| | CL Comparative specimen g | | 0.53 | 0.93 | 1.46 |
| Comparative | CL Comparative specimen b | FR Specimen 1 | 0.60 | 0.95 | 1.55 |
| Example 3 | CL Comparative specimen b | FR Specimen 2 | 0.59 | 0.99 | 1.58 |
| | CL Comparative specimen c | FR Specimen 1 | 0.55 | 0.93 | 1.48 |
| | CL Comparative specimen c | FR Specimen 2 | 0.56 | 0.97 | 1.53 |
| Comparative | CL Comparative specimen e | FR Specimen 5 | 0.58 | 0.93 | 1.51 |
| Example 4 | CL Comparative specimen e | FR Specimen 6 | 0.59 | 0.96 | 1.55 |
| | CL Comparative specimen f | FR Specimen 5 | 0.56 | 0.90 | 1.46 |
| | CL Comparative specimen f | FR Specimen 6 | 0.56 | 0.94 | 1.50 |
| Comparative | CL specimen 2 | FR Comparative specimen A | 0.82 | 0.69 | 1.51 |
| example 5 | CL specimen 2 | FR Comparative specimen B | 1.15 | 0.40 | 1.55 |
| | CL specimen 5 | FR Comparative specimen C | 0.60 | 1.18 | 1.78 |

¹⁾Bore specimen: Aluminum alloy material used for formation in the cylinder liner equivalent material
²⁾Ring material: Stainless steel used for formation in the first ring equivalent material and subjected to nitriding treatment
³⁾Worn amount of CL: Worn amount on the side in the cylinder liner equivalent material
⁴⁾Worn amount of FR: Worn amount on the side in the first ring equivalent material
⁵⁾Total worn amount: (Worn amount of CL) + (Worn amount of FR)

### Comparison Between Examples and Comparative Examples

Examples and Comparative Examples will be compared with reference to the above-mentioned Table 4 and Table 5. First, evaluation results of Examples will be described. “The worn amount in the cylinder liner equivalent material” of Examples is 0.41 μm to 0.59 μm, and all values are not more than 0.6 μm. Moreover, “the worn amount in the first ring equivalent material” is 0.83 μm to 0.97 μm, and values are not more than 1.0 μm. Further, “total worn amount that is sum of worn amount in both the cylinder liner equivalent material and the first ring equivalent material” is 1.35 μm to 1.45 μm, and all values are not more than 1.45 μm.

### Comparison Between Example 1 and Comparative Example 1

As is shown in Table 4 and Table 5, the same specimen “FR Specimen 3” is used in common for Example 1 and Comparative Example 1 as the first ring equivalent material. However as for the cylinder liner, the difference exists in that “CL specimen 1” to “CL specimen 7” were used in Example 1 but “CL Comparative Specimen a” to “CL Comparative Specimen g” were used in Comparative Example 1. In comparison on the worn amount between Example 1 and Comparative Example 1, a result shown below was obtained. First, when “the worn amount in the cylinder liner equivalent material” is compared, Example 1 shows an average value of 0.48 μm, and Comparative Example 1 shows an average value of 0.55 μm.

In comparison on “the worn amount in the first ring equivalent material”, Example 1 shows an average value of 0.90 μm, and Comparative Example 1 shows an average value of 0.95 μm.

When “total worn amount that is sum of worn amount in both the cylinder liner equivalent material and the first ring equivalent material” is compared, Example 1 shows an average value of 1.38 μm, and Comparative Example 1 shows an average value of 1.50 μm.

According to the above-mentioned result, in comparison between Example 1 and Comparative Example 1, Comparative Example 1 shows a larger value for the worn amount by approximately 0.05 μm in both “the worn amount in the cylinder liner equivalent material” and “the worn amount in the first ring equivalent material”. In “total worn amount that is sum of worn amount in both the cylinder liner equivalent material and the first ring equivalent material”, the maximum worn amount in Example 1 was 1.41 μm. On the other hand, in Comparative Example 1, all the specimens (“CL Comparative Specimen a” to “CL Comparative Specimen g”) shows a value exceeding 1.45 μm.

### Comparison Between Example 2 and Comparative Example 2

As shown in Table 4 and Table 5, the common specimen “FR Specimen 4” used in Examples is used for Example 2 and Comparative Example 2 for the first ring equivalent material. However, the cylinder liner used was different in that “CL specimen 1” to “CL specimen 7” were used in Example 2 and “CL Comparative Specimen a” to “CL Comparative Specimen g” were used in Comparative Example 2. In comparison on the worn amount between Example 2 and Comparative Example 2, a result shown below was obtained. In comparison on “the worn amount in the cylinder liner equivalent material”, Example 2 shows an average value of 0.50 μm, and Comparative Example 2 shows an average value of 0.55 μm.

In comparison on “the worn amount in the first ring equivalent material”, Example 2 shows an average value of 0.92 μm, and Comparative Example 2 shows an average value of 0.97 μm.

In comparison on “total worn amount that is sum of worn amount in both the cylinder liner equivalent material and the first ring equivalent material”, Example 2 shows an average value of 1.42 μm, and Comparative Example 2 shows an average value of 1.53 μm.

According to the above-mentioned result in comparison between Example 2 and Comparative Example 2, Comparative Example 2 showed a larger value of the worn amount by approximately 0.05 μm in both “the worn amount in the cylinder liner equivalent material” and “the worn amount in the first ring equivalent material”. As for “total worn amount that is sum of worn amount in both the cylinder liner equivalent material and the first ring equivalent material”, the maximum worn amount in Example 2 was 1.45 μm. On the other hand, in Comparative Example 2 (“CL Comparative Specimen a” to “CL Comparative Specimen g”), all the specimens showed a value exceeding 1.45 μm.

### Comparison Between Example 3 and Comparative Example 3

As shown in Table 4 and Table 5, the common specimens “FR Specimen 1” and “FR Specimen 2” used in Examples were used for both Example 3 and Comparative Example 3 for the first ring equivalent material. However, the cylinder liner equivalent material used was different in that “CL specimen 2”, “CL specimen 5” and “CL specimen 7” were used in Example 3 and “CL Comparative Specimen b” and “CL Comparative Specimen c” were used in Comparative Example 3. In comparison between Example 3 and Comparative Example 3 on the worn amount, a result shown below was obtained. In comparison on “the worn amount in the cylinder liner equivalent material”, Example 3 shows an average value of 0.50 μm, and Comparative Example 3 shows an average value of 0.58 μm.

In comparison on “the worn amount in the first ring equivalent material”, Example 3 shows an average value of 0.92 μm, and Comparative Example 3 shows an average value of 0.96 μm.

In comparison on “total worn amount that is sum of worn amount in both the cylinder liner equivalent material and the first ring equivalent material”, Example 3 shows an average value of 1.42 μm, and Comparative Example 3 shows an average value of 1.54 μm.

According to the above-mentioned result, in comparison between Example 3 and Comparative Example 3, Comparative Example 3 shows a larger average value of approximately 0.05 μm in the worn amount for both “the worn amount in the cylinder liner equivalent material” and “the worn amount in the first ring equivalent material”. As for “total worn amount that is sum of worn amount in both the cylinder liner equivalent material and the first ring equivalent material”, the maximum worn amount was 1.45 μm in Example 3. On the other hand, all the specimens of “CL Comparative Specimen b” and “CL Comparative Specimen c” show a value exceeding 1.45 μm in Comparative Example 3.

### Comparison Between Example 4 and Comparative Example 4

As shown in Table 4 and Table 5, the common specimens “FR Specimen 5” and “FR Specimen 6” used in Examples were used for both Example 4 and Comparative Example 4 as the first ring equivalent material. However, the cylinder liner used was different in that “CL specimen 2”, “CL specimen 5” and “CL specimen 7” were used in Example 4 and “CL Comparative Specimen e” and “CL Comparative Specimen f” were used in Comparative Example 4: In comparison between Example 4 and Comparative Example 4 on the worn amount, a result shown below was obtained. In comparison on “the worn amount in the cylinder liner equivalent material”, Example 4 shows an average value of 0.52 μm, and Comparative Example 4 shows an average value of 0.57 μm.

In comparison on “the worn amount in the first ring equivalent material”, Example 4 shows an average value of 0.89 μm, and Comparative Example 4 shows an average value of 0.93 μm.

In comparison on “total worn amount that is sum of worn amount in both the cylinder liner equivalent material and the first ring equivalent material”, Example 4 shows an average value of 1.40 μm, and Comparative Example 4 shows an average value of 1.51 μm.

According to the above-mentioned result, in comparison between Example 4 and Comparative Example 4, Comparative Example 4 showed a larger average value approximately 0.05 μm for the worn amount in both “the worn amount in the cylinder liner equivalent material” and “the worn amount in the first ring equivalent material”. As for “total worn amount that is sum of worn amount in both the cylinder liner equivalent material and the first ring equivalent material”, the maximum worn amount in Example 4 was 1.45 μm. On the other hand, in Comparative Example 4, all the specimens of “CL Comparative Specimen e” and “CL Comparative Specimen f” show a value exceeding 1.45 μm.

### Comparison Between Examples 1 and 2 and Comparative Example 5

As shown in Table 4 and Table 5, Comparative Example 5 is different from Comparative Examples 1 to 4 in that a specimen used for the first ring equivalent material has a composition out of the range of Examples. Specifically, as shown in Table 5, a first ring equivalent material used in Comparative Example 5 was manufactured with martensite stainless steel (“FR Comparative Specimen A” and “FR Comparative Specimen B”) which is harder than the first ring equivalent material (“FR Specimen 1” to “FR Specimen 6”) manufactured with austenite stainless steel used in Examples. As for “FR Comparative Specimen C”, a specimen having the same composition with “FR Specimen 3” and “FR Specimen 4” used in Examples was used.

Moreover, as for the cylinder liner equivalent material, it is common in Example 1, Example 2, and Comparative Example 5 including “CL specimen 2” and “CL specimen 5”. So, as for Example 1 and Example 2, comparison with Comparative Example 5 will be made by paying attention to just the specimen corresponding to “CL specimen 2” and “CL specimen 5”. In addition, “CL specimen 2” of Examples was used for the cylinder liner equivalent material when “FR Comparative Specimen A” and “FR Comparative Specimen B” were used in Comparative Example 5. So, Example 1 and Example 2 using the specimen “CL specimen 2” were compared to Comparative Example 5 using “FR Comparative Specimen A” and “FR Comparative Specimen B”. The summary is shown below.

In comparison on “the worn amount in the cylinder liner equivalent material”, Example 1 and Example 2 show 0.48 μm and 0.50 μm, respectively, and Comparative Example 5 show 0.82 μm and 1.15 μm, respectively.

In comparison on “the worn amount in the first ring equivalent material”, Example 1 and Example 2 show 0.92 μm and 0.94 μm, respectively, and Comparative Example 5 show 0.69 μm and 0.40 μm, respectively.

In comparison on “total worn amount that is sum of worn amount in both the cylinder liner equivalent material and the first ring equivalent material”, Example 1 and Example 2 show 1.40 μm and 1.44 μm, respectively, and Comparative Example 5 show 1.51 μm and 1.55 μm, respectively.

According to the above-mentioned result, in comparison between Examples 1 and 2 and Comparative Example 5, Comparative Example 5 shows a very large worn amount on “the worn amount in the cylinder liner equivalent material”. On the other hand, Examples 1 and 2 show a larger worn amount on “the worn amount in the first ring equivalent material”. On “total worn amount that is sum of worn amount in both the cylinder liner equivalent material and the first ring equivalent material”, the maximum worn amount was not more than 1.45 μm in Example 1 and Example 2. On the other hand, Comparative Example 5 shows a value exceeding 1.45 μm in the specimens of both “FR Comparative Specimen A” and “FR Comparative Specimen B”.

The reason why the above-mentioned result is obtained can be considered that the first ring equivalent material manufactured with austenite stainless steel (“FR Specimen 3” and “FR Specimen 4”) were used in Example 1 and Example 2 while the first ring equivalent material manufactured with hard martensite stainless steel (“FR Comparative Specimen A” and “FR Comparative Specimen B”) were used in Comparative Example 5. As shown in Table 5, “the worn amount of cylinder liner equivalent material” in “FR Comparative Specimen A” and “FR Comparative Specimen B” used in Comparative Example 5 are particularly large against to “the worn amount of first ring equivalent material”. In such combination structure of the first ring equivalent material and the cylinder liner equivalent material, too large attack of the first ring equivalent material to the cylinder liner equivalent material may make durability performance poor.

As described above, it is made clear that excellent wear resistance performance can be obtained in Examples in which the features of the present invention are reflected, but excellent wear resistance performance is hardly obtained when the first ring equivalent material has a surface roughness out of the range of the above-mentioned surface roughness properties 2 even if it is the first ring equivalent material using austenite stainless steel. So, it can be recognized that the surface roughness properties of the respective sliding surfaces in the cylinder liner and the piston ring are a very important factor.

Moreover, in the investigation on “FR Specimen 1” in FIG. 2(a) and “FR Specimen 3” in FIG. 2(b), the nitride layer 10 on the austenite stainless steel 20 comprises a very uniform structure, i.e. excellent penetration of nitrogen is carried out in the nitriding treatment. In contrast, the nitride layer 10 formed on the martensite stainless steel 20 shown in “FR Comparative Specimen A” in FIG. 5(a) and “FR Comparative Specimen B” in FIG. 5(b) contain plate-like and/or granular chromium nitrides, and the nitrides may attack the “bore specimen” made of an aluminum system alloy. So, it can be said that when nitriding treatment is performed on martensite stainless steel, not only a difference in hardness of the material itself between martensite stainless steel and austenite stainless steel itself but also a difference in hardness of the nitride surface is made large. As a result, a martensite stainless steel after nitriding treatment is made to give more wear damage to a partner member in sliding operation with friction.

As described above, it can be recognized that the first ring equivalent material manufactured with martensite stainless steel gives larger wear to the cylinder liner (CL specimen 2) even if the surface roughness properties are arranged to be same with the first ring manufactured with austenite stainless steel used in the present invention.

Next, on the case where “FR Comparative Specimen C” of Comparative Example 5 is used will be described. As is shown in Table 5, “CL specimen 5” of Examples is used for “FR Comparative Specimen C” of Comparative Example 5 as the cylinder liner equivalent material. In comparison among the specimens “CL specimen 5” in Examples 1 and 2 and “FR Comparative Specimen C” in Comparative Example 5, it can be summarized as shown below. In comparison on “the worn amount in the cylinder liner equivalent material”, Example 1 and Example 2 show 0.44 μm and 0.48 μm, and Comparative Example 5 shows 0.60 μm.

Next, in comparison on “the worn amount in the first ring equivalent material”, both Example 1 and Example 2 show 0.92 μm, and Comparative Example 5 shows 1.18 μm.

In comparison on “total worn amount that is sum of worn amount in both the cylinder liner equivalent material and the first ring equivalent material”, Example 1 and Example 2 show 1.36 μm and 1.40 μm, and Comparative Example 5 shows 1.78 μm.

According to the above-mentioned result, in comparison between Example 1 and 2 and Comparative Example 5, Comparative Example 5 shows a remarkably larger worn amount in “the worn amount in the cylinder liner equivalent material” and “the worn amount in the first ring equivalent material”. As for “total worn amount that is sum of worn amount in both the cylinder liner equivalent material and the first ring equivalent material”, the maximum sum worn amount obtained in Examples 1 and 2 was not more than 1.45 μm. On the other hand, Comparative Example 5 shows a value far exceeding 1.45 μm.

Furthermore, in comparison between “FR Specimen 3” and “FR Specimen 4” used in Examples 1 and 2 and “FR Comparative Specimen C” used in Comparative Example 5 disclosed in Tables 3 to 5, the nitride layer is almost same in a thickness of 80 μm and a hardness of 1050 HV0.1. However, when “FR Comparative Specimen C” is compared with the first ring equivalent material (“FR Specimen 3” and “FR Specimen 4”) manufactured with austenite stainless steel used in Example 2, the material was same in Comparative Example 5 but a value of the surface roughness was larger, i.e. “FR Comparative Specimen C” which surface properties are out of the range of the above-mentioned surface roughness properties 2 was used in combination with the cylinder liner (“CL specimen 1” and “CL specimen 2”) used in Example 2 in Comparative Example 5. Specifically, as for the surface roughness in the first ring, “FR Specimen 3” was Rz_{JIS94} of 0.7 μm and Rk of 0.06 μm, “FR Specimen 4” was Rz_{JIS94} of 1.6 μm and Rk of 0.3 μm, and “FR Comparative Specimen C” was Rz_{JIS94} of 1.7 μm and Rk of 0.36 μm. It can be summarized clearly that when the cylinder liner equivalent material having the properties within the range specified in the present invention is used, durability is made poor with the roughness exceeding Rz_{JIS94} of 1.6 μm and Rk of 0.3 μm in the first ring equivalent material.

Comparison between “CL specimen 2” and “CL Comparative Specimen b”: Comparison between “CL specimen 2” used in Examples 1 and 2 and “CL Comparative Specimen b” used in Comparative Examples 1 and 2 described in Tables 4 and 5 will be summarized below. The difference between “CL specimen 2” and “CL Comparative Specimen b” is that “CL Comparative Specimen b” has a larger surface roughness exceeding the upper limit of the range of the surface roughness properties 1 of the present invention. Comparison will be made on worn amounts among the combination structures of the first ring equivalent material “FR Specimen 3” in common and the cylinder liner equivalent materials of “CL specimen 2” and “CL Comparative Specimen b” described in Table 4 and Table 5 for Example 1 and Comparative Example 1. As for “the worn amount in the cylinder liner equivalent material”, “CL specimen 2” show 0.48 μm and “CL Comparative Specimen b” show 0.61 μm. As for “the worn amount in the first ring equivalent material”, “CL specimen 2” show 0.92 μm and “CL Comparative Specimen b” show 0.94 μm. As for “total worn amount that is sum of worn amount in both the cylinder liner equivalent material and the first ring equivalent material”, “CL specimen 2” show 1.40 μm and “CL Comparative Specimen b” show 1.55 μm.

Next, Comparison will be made on worn amounts among the combination structures of the first ring equivalent material “FR Specimen 4” in common and the cylinder liner equivalent materials of “CL specimen 2” and “CL Comparative Specimen b” described in Table 4 and Table 5 for Example 2 and Comparative Example 2. As for “the worn amount in the cylinder liner equivalent material”, “CL specimen 2” show 0.50 μm and “CL Comparative Specimen b” show 0.60 μm. As for “the worn amount in the first ring equivalent material”, “CL specimen 2” show 0.94 μm and “CL Comparative Specimen b” show 0.98 μm. As for “total worn amount that is sum of worn amount in both the cylinder liner equivalent material and the first ring equivalent material”, “CL specimen 2” show 1.44 μm and “CL Comparative Specimen b” show 1.58 μm.

According to the above-mentioned result, it is made clear that when the surface roughness of the cylinder liner exceeds the upper limit of the range of the surface roughness properties 1 of the present invention, wear resistance performance in the cylinder liner is made poor. Such tendency is also summarized in comparison between “CL specimen 5” and “CL Comparative Specimen e” shown in Table 4 and Table 5.

As described above, it can be recognized that wear resistance properties equal to the combination structure of the cylinder liner and the first ring equivalent material according to the present invention is not obtained when the first ring equivalent material (“FR Specimen 1” to “FR Specimen 6”) manufactured with austenite stainless steel used in the present invention is just combined with the cylinder liner having properties different from the conditions of the present invention.

### Summary in Comparison Among Examples and Comparative Examples

In comparison among Examples and Comparative Examples mentioned above, it can be recognized that when the cylinder manufactured with an aluminum alloy is used, the surface roughness properties of the respective sliding surfaces in the cylinder liner and the piston ring are most important to reduce mutual damage such as abrasive wear, damage by friction, etc caused by a sliding operation between the cylinder liner and the piston ring (first ring equivalent material). Further, it can be recognized that it is important to select the most suitable combination structure from a viewpoint of the quality of the material in the cylinder liner and that of the piston ring.

### INDUSTRIAL APPLICABILITY

The combination structure of the piston ring and the cylinder liner for the internal combustion engine according to the present invention can minimize wear in both the cylinder liner and the sliding surface of the piston ring, and can effectively reduce mutual damage by friction at the cylinder liner and the piston ring accompanied with the sliding operation by controlling the surface roughness properties in the cylinder liner that constitutes the inner circumferential surface of the cylinder made of an aluminum alloy and the surface roughness of the sliding surface of the piston ring against to the inner circumferential surface of the cylinder liner, and optimally selecting the material for the cylinder liner and that of the piston ring. As a result, life span of internal combustion engines such as engines for automobiles and the like can be increased, and durability thereof can be drastically improved.

### BRIEF DESCRIPTION OF THE DRAWINGS

FIG. 1 is a diagram showing a relationship between a thickness of a nitride layer formed on stainless steel and a Vickers hardness of the nitride layer;

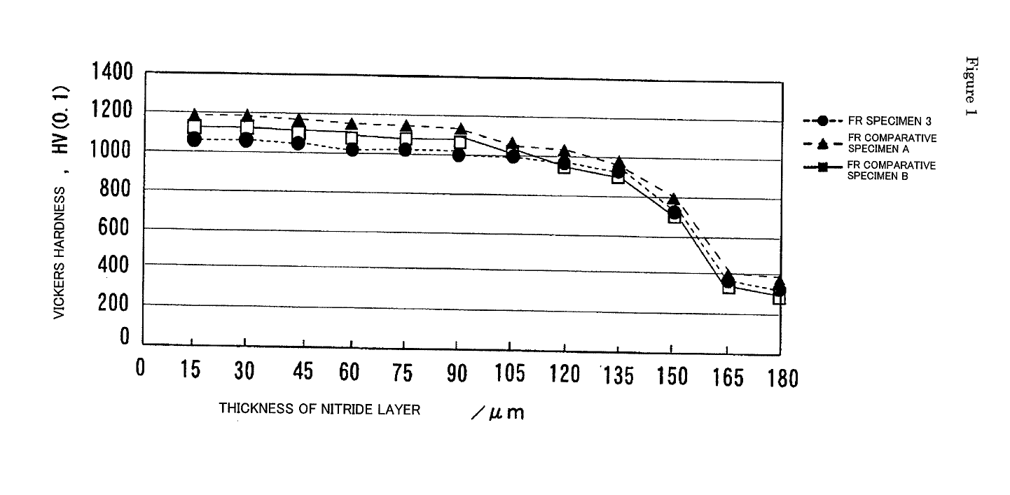

FIG. 2 shows an observed image of a cross sectional view of a nitride layer on a first ring used in Example, which is investigated by using a metallurgical microscope;

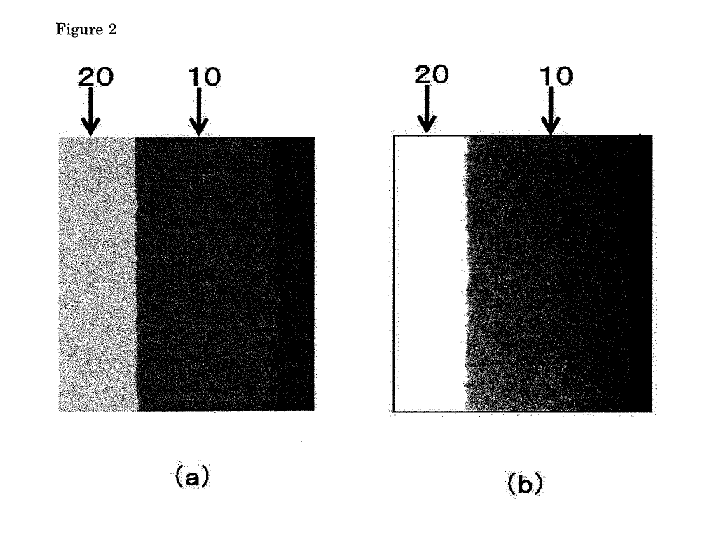

FIG. 3 is a schematic view for showing a constitution concept of a wear tester used herein;

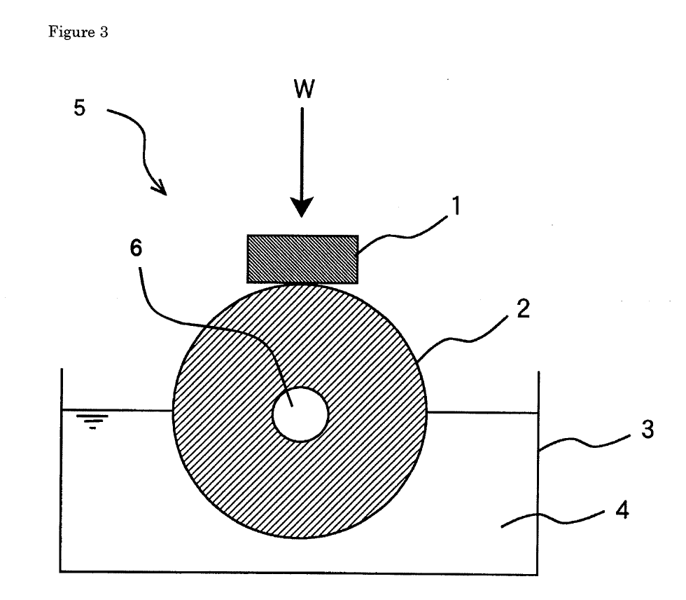

FIG. 4 shows a graph showing a result of a fatigue test on a piston ring according to Examples and Comparative Examples; and

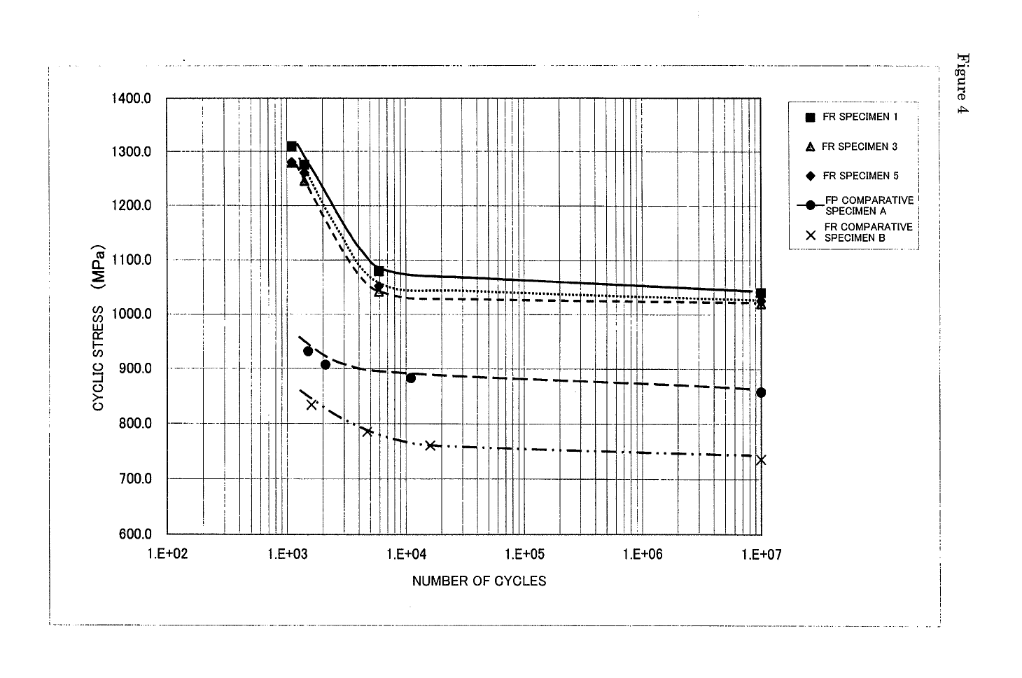

FIG. 5 shows an observed image of a cross sectional view of a nitride layer of a first ring used in Comparative Example, which is investigated by using a metallurgical microscope.

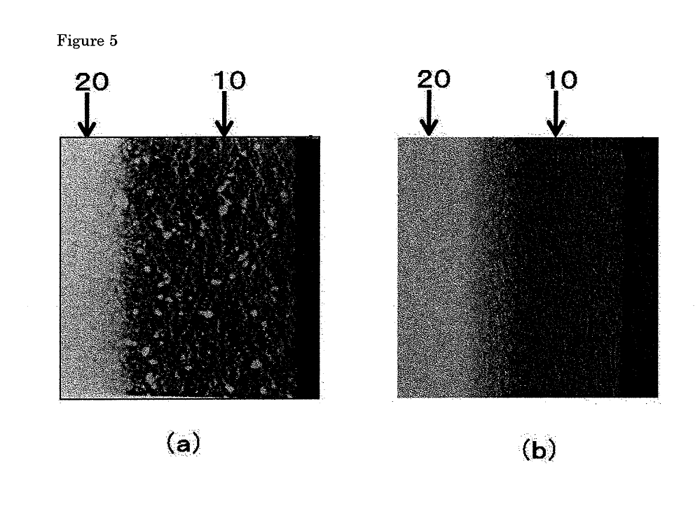

### DESCRIPTION OF SYMBOLS

1 piston ring material
2 bore specimen
3 oil bath
4 lubricating oil
5 wear tester
6 rotational rotor
10 nitride layer
20 stainless steel
W load

1. A combination structure of a piston ring and a cylinder liner for an internal combustion engine in which the piston ring provided on a piston of the internal combustion engine is arranged to slide along the cylinder liner while keeping a predetermined contact pressure against to the cylinder liner which constitutes an inner circumferential surface of the cylinder that is made of an aluminum alloy and holds the piston, wherein
the inner circumferential surface of the cylinder liner comprises surface roughness properties 1 of conditions (1) to (4) shown below:
[Surface Roughness Properties 1]
(1) a ten-point height of roughness profile (Rz_{JIS94}) provided in JIS B 0601 (1994) is 0.5 μm to 1.0 μm,
(2) a core roughness depth (Rk) provided in DIN 4776 is 0.2 μm to 0.4 μm,
(3) a reduced peak height (Rpk) provided in DIN 4776 is 0.05 μm to 0.1 μm, and
(4) a reduced valley depths (Rvk) provided in DIN 4776 is 0.08 μm to 0.2 μm;
the sliding surface of the piston ring against to an inner circumferential surface in the cylinder liner comprises surface roughness properties 2 of conditions (a) and (b) shown below:
[Surface Roughness Properties 2]
(a) a ten-point height of roughness profile (Rz_{JIS94}) provided in JIS B 0601 (1994) is not more than 1.6 μm, and
(b) a reduced peak height (Rpk) provided in DIN 4776 is not more than 0.3 μm; and
the piston ring provided on the piston is used at a contact pressure of 0.03 MPa to 0.2 MPa against to the inner circumferential surface of the cylinder liner.

2. The combination structure of the piston ring and the cylinder liner for an internal combustion engine according to claim 1, wherein the cylinder liner is made of the alloy comprising the alloy composition for a cylinder liner 1 shown below:
[Alloy composition for a cylinder liner 1]
silicon: 20.0 mass % to 28.0 mass %
magnesium: 0.4 mass % to 2.0 mass %
copper: 2.0 mass % to 4.5 mass %
iron: not more than 0.60 mass %
nickel: not more than 0.01 mass %
balance: aluminum and inevitable impurities.

3. The combination structure of the piston ring and the cylinder liner for an internal combustion engine according to claim 1, wherein the cylinder liner is made of the alloy comprising the alloy composition for a cylinder liner 2 shown below:
[Alloy composition for a cylinder liner 2]
silicon: 20.0 mass % to 28.0 mass %
magnesium: 0.8 mass % to 2.0 mass %
copper: 3.0 mass % to 4.5 mass %
iron: 1.0 mass % to 1.4 mass %
nickel: 1.0 mass % to 5.0 mass %
balance: aluminum and inevitable impurities.

4. The combination structure of the piston ring and the cylinder liner for an internal combustion engine according to claim 1, wherein the piston ring is made of the austenite stainless steel comprising an alloy composition for a piston ring shown below:
[Alloy Composition for a Piston Ring]
nickel: 3.5 mass % to 15.0 mass %
chromium: 13.0 mass % to 20.0 mass %
carbon: not more than 0.15 mass %
silicon: not more than 1.0 mass %
manganese: not more than 7.5 mass %
phosphorus: not more than 0.06 mass %
sulfur: not more than 0.03 mass %
balance: iron and inevitable impurities.

5. The combination structure of the piston ring and the cylinder liner for an internal combustion engine according to claim 4, wherein the piston ring is characterized in that the alloy composition for a piston ring further comprises molybdenum of 1 mass % to 4 mass %.

6. The combination structure of the piston ring and the cylinder liner for an internal combustion engine according to claim 1, wherein the sliding surface of the piston ring against to the inner circumferential surface in the cylinder liner comprises a nitride layer having a thickness of 30 μm to 150 μm on the surface and a Vickers hardness (HV) on the surface of 900 HV0.1 to 1200 HV0.1.

7. The combination structure of the piston ring and the cylinder liner for an internal combustion engine according to claim 1, wherein the sliding surface of the piston ring slide against to the inner circumferential surface in the cylinder liner comprises a diamond-like carbon layer on the surface of the sliding surface of the piston ring.

8. The combination structure of the piston ring and the cylinder liner for an internal combustion engine according to claim 1, wherein both an upper surface of the piston ring and a bottom surface of the piston ring to be settled in a piston ring groove of the piston ring comprise a resin coat layer formed by using either of a heat resistant resin or a filler-containing heat resistant resin which a heat resistant resin contains an inorganic filler.

9. The combination structure of the piston ring and the cylinder liner for an internal combustion engine according to claim 8, wherein the heat resistant resin is either of a polybenzimidazole resin or a polyamide-imide resin each having a heat resisting temperature of not less than 150° C.

10. The combination structure of the piston ring and the cylinder liner for an internal combustion engine according to claim 8, wherein upper surface of the piston ring and bottom surface of the piston ring comprise a roughened surface prepared by chemical treatment, and the resin coat layer is provided on the roughened surface.

11. An internal combustion engine wherein the combination structure of the piston ring and the cylinder liner for an internal combustion engine according to claim 1.
